(19) United States
(12) Patent Application Publication
(10) Pub. No.: US 2016/0262184 A1
(43) Pub. Date: Sep. 8, 2016

(54) WI-FI COMPATIBLE DEDICATED PROTOCOL INTERVAL ANNOUNCEMENT

(71) Applicant: QUALCOMM Incorporated, San Diego, CA (US)

(72) Inventor: Maarten Menzo Wentink, Naarden (NL)

(21) Appl. No.: 15/157,255

(22) Filed: May 17, 2016

Related U.S. Application Data
(63) Continuation-in-part of application No. 14/538,658, filed on Nov. 11, 2014.
(60) Provisional application No. 61/904,374, filed on Nov. 14, 2013.
(60) Provisional application No. 62/163,050, filed on May 18, 2015.

(51) Int. Cl. H04W 74/08; H04L 29/12; H04L 1/16; H04W 74/00

(52) U.S. Cl. CPC H04W 74/0816; H04W 74/004; H04W 74/006; H04L 61/6022; H04L 1/1628; H04W 84/12

(57) ABSTRACT

A wireless device may receive a dedicated protocol interval (DPI) announcement (DPIA) frame, and then determine, based on the DPIA frame, a scheduled time and a dedicated protocol for the DPI. The wireless device may transmit one or more dedicated clear-to-send (CTS) frames requesting legacy stations to defer from contending for medium access during the DPI. Then, the wireless device may transmit data, using the dedicated protocol, to another device during the DPI.

### CROSS REFERENCE TO RELATED APPLICATIONS

This application is a continuation-in-part of and claims priority to co-pending and commonly owned U.S. patent application Ser. No. 14/538,658 entitled “SYSTEMS AND METHODS FOR IMPROVED COMMUNICATION EFFICIENCY IN HIGH EFFICIENCY WIRELESS NETWORKS” filed on Nov. 11, 2014, which in turn claims priority to U.S. Provisional Patent Application No. 61/904,374 entitled “SYSTEMS AND METHODS FOR IMPROVED COMMUNICATION EFFICIENCY IN HIGH EFFICIENCY WIRELESS NETWORKS,” filed on Nov. 14, 2013, the entireties of both of which are hereby incorporated by reference. This application also claims priority to co-pending and commonly owned U.S. Provisional Patent Application No. 62/163,050 entitled “WI-FI COMPATIBLE DEDICATED PROTOCOL INTERVAL ANNOUNCEMENT PROTOCOL” filed on May 18, 2015, the entirety of which is incorporated by reference herein.

### BACKGROUND

The example embodiments relate generally to wireless networks, and specifically to the coexistence of wireless devices that employ different channel access mechanisms.

### TECHNICAL FIELD

A WiFi® network may be formed by one or more access points (APs) that provide a wireless communication channel or link with a number of client devices or stations (STAs). Each AP, which may correspond to a Basic Service Set (BSS), periodically broadcasts beacon frames to enable any STAs within wireless range of the AP to establish and/or maintain a communication link with the Wi-Fi network. The beacon frames, which may include a traffic indication map (TIM) indicating whether the AP has queued downlink data for the STAs, are typically broadcast according to a target beacon transmission time (TBTT) schedule.

In many wireless local area networks (WLANs), only one device may use the shared wireless medium at any given time. To arbitrate access to the shared wireless medium, the IEEE 802.11 standards provide Carrier Sense Multiple Access with Collision Avoidance (CSMA/CA) techniques that allow wireless devices to randomly access the wireless medium in a manner that minimizes collisions. For example, to prevent multiple devices from accessing the wireless medium at the same time, each device may contend for medium access using a random channel access mechanism that uses an exponential back-off procedure.

The IEEE 802.11ax standards may introduce multiple access mechanisms that allow multiple devices to transmit and/or receive data on a shared wireless medium at the same time. For example, in a multiple access wireless network, the available frequency spectrum may be divided into a plurality of resource units (RUs) each including a number of different frequency subcarriers, and different RUs may be allocated or assigned to different wireless devices at a given point in time. In this manner, multiple wireless devices may concurrently transmit data on the wireless medium using their assigned RU or frequency subcarriers. Further, in contrast to conventional wireless networks in which wireless devices typically contend with each other for medium access, wireless networks operating according to the IEEE 802.11ax standards may allow medium access to be scheduled for the wireless devices, for example, to reduce transmission latencies associated with medium access contention operations.

When a wireless medium is shared by a number of older wireless devices that employ random channel access mechanisms and by a number of newer wireless devices for which medium access is scheduled, operation of the older wireless devices may interfere with operation of the newer wireless devices. Thus, it would be desirable for newer wireless devices that receive scheduled grants of medium access to co-exist on the same wireless medium as older wireless devices that employ random channel access mechanisms.

### SUMMARY

This Summary is provided to introduce in a simplified form a selection of concepts that are further described below with respect to the Detailed Description. This Summary is not intended to identify key features or essential features of the claimed subject matter, nor is it intended to limit the scope of the claimed subject matter.

Apparatus and methods are disclosed that may allow for a wireless device to signal an upcoming dedicated protocol interval (DPI). In one example, a wireless device may receive a DPI announcement (DPIA) frame; determine, based on the DPIA frame, a duration of the DPI and a dedicated protocol for the DPI; transmit one or more dedicated clear-to-send (CTS) frames requesting legacy stations to defer from contending for medium access during the DPI; and transmit data, using the dedicated protocol, to another device during the DPI.

In another example, a wireless device is disclosed. The wireless may include one or more processors, one or more transceivers, and a memory. The memory stores instructions that, when executed by the one or more processors, cause the wireless device to signal a dedicated protocol interval by performing operations that include receiving a DPI announcement (DPIA) frame; determining, based on the DPIA frame, a duration of the DPI and a dedicated protocol for the DPI; transmitting one or more dedicated clear-to-send (CTS) frames requesting legacy stations to defer from contending for medium access during the DPI; and transmitting data, using the dedicated protocol, to another device during the DPI.

In another example, a non-transitory computer-readable storage medium is disclosed that stores one or more programs containing instructions that, when executed by one or more processors of a wireless device, cause the wireless device to signal a dedicated protocol interval (DPI) by performing operations comprising receiving a DPI announcement (DPIA) frame; determining, based on the DPIA frame, a duration of the DPI and a dedicated protocol for the DPI; transmitting one or more dedicated clear-to-send (CTS) frames requesting legacy stations to defer from contending for medium access during the DPI; and transmitting data, using the dedicated protocol, to another device during the DPI.

In another example, a wireless device for signaling a dedicated protocol interval (DPI) is disclosed. The wireless device may include means for receiving a DPI announcement (DPIA) frame; means for determining, based on the DPIA frame, a duration of the DPI and a dedicated protocol for the DPI; means for transmitting one or more dedicated clear-to-send (CTS) frames requesting legacy stations to defer from contending for medium access during the DPI; and means for transmitting data, using the dedicated protocol, to another device during the DPI.

### BRIEF DESCRIPTION OF THE DRAWINGS

The example embodiments are illustrated by way of example and are not intended to be limited by the figures of the accompanying drawings. Like reference numerals refer to corresponding parts throughout the drawing figures.

FIG. 1 shows an example wireless system within which the example embodiments may be implemented.

FIG. 2 shows a block diagram of a wireless device in accordance with example embodiments.

FIG. 3A shows an example clear to send (CTS) frame.

FIG. 3B shows an example protocol identifier address, in accordance with example embodiments.

FIG. 4 shows an example MAC header.

FIG. 5 shows an example CTS frame indicating information added to one or more fields.

FIG. 6 shows an example ready to send (RTS) frame.

FIG. 7 is a flow chart depicting an example operation for managing communications in a wireless network, in accordance with example embodiments.

FIG. 8 is a functional block diagram of an example device that may be one embodiment of the wireless devices of FIG. 1.

FIG. 9 is a timing diagram depicting an example operation for accessing a wireless medium, in accordance with example embodiments.

FIG. 10 is a timing diagram depicting another example operation for accessing a wireless medium, in accordance with example embodiments.

FIG. 11 is a timing diagram depicting yet another example operation for accessing a wireless medium, in accordance with example embodiments.

FIG. 12 is a flowchart depicting an example operation for managing communications in a wireless network, in accordance with example embodiments.

FIG. 13 is a functional block diagram of an apparatus that may be one embodiment of the wireless devices of FIG. 1.

FIG. 14 is a flowchart depicting another example operation for managing communications in a wireless network, in accordance with example embodiments.

FIG. 15 is a functional block diagram of another apparatus that may be one embodiment of the wireless devices of FIG. 1.

FIG. 16 is a timing diagram depicting the coordination of an example dedicated protocol interval (DPI), in accordance with example embodiments.

FIG. 17 shows an illustrative flow chart depicting an example operation for coordinating a dedicated protocol interval, in accordance with example embodiments.

FIG. 18 shows an illustrative flow chart depicting another example operation for coordinating a dedicated protocol interval, in accordance with example embodiments.

### DETAILED DESCRIPTION

The example embodiments are described below in the context of WLAN systems for simplicity only. It is to be understood that the example embodiments are equally applicable to other wireless networks (e.g., cellular networks, pico networks, femto networks, satellite networks), as well as for systems using signals of one or more wired standards or protocols (e.g., Ethernet and/or HomePlug/PLC standards). As used herein, the terms “WLAN” and “Wi-Fi®” may include communications governed by the IEEE 802.11 family of standards, Bluetooth, HiperLAN (a set of wireless standards, comparable to the IEEE 802.11 standards, used primarily in Europe), and other technologies having relatively short radio propagation range. Thus, the terms “WLAN” and “Wi-Fi” may be used interchangeably herein. In addition, although described below in terms of an infrastructure WLAN system including one or more APs and a number of STAs, the example embodiments are equally applicable to other wireless systems including, for example, multiple WLANs, peer-to-peer (or Independent Basic Service Set) systems, Wi-Fi Direct systems, Wi-Fi Hotspots, and/or Long-Term Evolution in Unlicensed Spectrum (LTE-U) implementations. In addition, although described herein in terms of exchanging data frames between wireless devices, the example embodiments may be applied to the exchange of any data unit, packet, and/or other frames between wireless devices. Thus, the term “frame” may include any frame, packet, or data unit such as, for example, protocol data units (PDUs), MAC protocol data units (MPDUs), and physical layer convergence procedure protocol data units (PPDUs). The term “A-MPDU” may refer to aggregated MPDUs.

In the following description, numerous specific details are set forth such as examples of specific components, circuits, and processes to provide a thorough understanding of the present disclosure. The term “coupled” as used herein means connected directly to or connected through one or more intervening components or circuits. The term “number” as used herein may refer to an integer value greater than or equal to 0. The term “medium access” as used herein may refer to gaining and/or controlling access to a shared wireless medium. The term “transmit opportunity” (TXOP) as used herein may refer to a period of time during which a device may transmit data via the shared wireless medium.

Further, as used herein, the term “HT” may refer to a high throughput frame format or protocol defined, for example, by the IEEE 802.11n standards. The term “VHT” may refer to a very high throughput frame format or protocol defined, for example, by the IEEE 802.11ac standards. The term “HE” may refer to a high efficiency frame format or protocol defined, for example, by the IEEE 802.11ax standards. In addition, the term “HEW device” may refer to a high efficiency wireless device capable of operating according to protocols defined by the IEEE 802.11ax standards, the term “HE STA” may refer to a wireless station capable of operating according to protocols defined by the IEEE 802.11ax standards, and the term “HE AP” may refer to a wireless access point capable of operating according to protocols defined by the IEEE 802.11ax. Thus, for at least some implementations, the term “HEW device” as used herein may refer to a HE STA and/or a HE AP.

The term “non-HT” may refer to a frame format or protocol defined, for example, by the IEEE 802.11a/g standards. The term “non-HE” may refer to a legacy frame format or protocol defined, for example, by the IEEE 802.11a/g/n/ac standards. Further, term “non-HE STA” may refer to a wireless station that may operate in accordance with the IEEE 802.11a/g/n/ac standards but not the IEEE 802.11ax standards, the term “non-HE AP” may refer to a wireless access point that may operate in accordance with the IEEE 802.11a/g/n/ac standards but not the IEEE 802.11ax standards, and the term “non-HEW device” may refer to a wireless device that may operate in accordance with the IEEE 802.11a/g/n/ac standards but not the IEEE 802.11ax standards. Thus, for at least some implementations, the term “non-HEW device” as used herein may refer to a non-HE STA and/or a non-HE AP. Accordingly, in some aspects, the terms “non-HEW device,” “legacy device,” “non-HE STA,” and “non-HE AP” may be used interchangeably herein.

Also, in the following description and for purposes of explanation, specific nomenclature is set forth to provide a thorough understanding of the example embodiments. However, it will be apparent to one skilled in the art that these specific details may not be required to practice the example embodiments. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components.

As mentioned above, in many WLANs, only one device may use a shared wireless medium at any given time. To arbitrate access to the shared wireless medium, the IEEE 802.11 standards define a distributed coordination function (DCF) that instructs individual STAs (and APs) to “listen” to the wireless medium to determine when the wireless medium is idle (e.g., using a “carrier sense” technique). For example, only when a STA detects that the wireless medium has been continuously idle for a DCF Interframe Space (DIFS) duration may the STA attempt to transmit data on the wireless medium. To prevent multiple devices from accessing the wireless medium at the same time, each device may select a random “back-off” number or period. More specifically, during a contention period, each device waits for a period of time determined by its back-off number (e.g., its back-off period) before it attempts to transmit data on the wireless medium. The device that selects the lowest back-off number “wins” the contention operation, and may be granted access to the shared wireless medium for a period of time commonly referred to as a transmit opportunity (TXOP). If multiple devices select the same back-off value and then attempt to transmit data at the same time, a collision occurs and the devices may contend for medium access again using an exponential back-off procedure.

The IEEE 802.11ax standards may employ multiple access mechanisms, such as orthogonal frequency-division multiple access (OFDMA) techniques, to allow multiple devices to transmit and/or receive data on a shared wireless medium at the same time. The available frequency spectrum of an OFDMA-based wireless network may be divided into a plurality of resource units (RUs) each including a number of different frequency subcarriers, and different RUs may be allocated or assigned to different wireless devices at a given point in time. In this manner, multiple wireless devices may concurrently transmit data on the wireless medium using their assigned RU(s) or frequency subcarriers.

Access to the wireless medium of an OFDMA-based wireless network may be scheduled to avoid (or at least minimize) collisions. For example, an AP operating in an OFDMA-based wireless network may select the size and location of an RU upon which each STA may transmit data, and may inform each STA of its assigned RU in a trigger frame. The trigger frames may also schedule concurrent uplink (UL) data transmissions from different STAs, for example, to avoid contention operations associated with random channel access mechanisms.

As mentioned above, the operation of HEW devices may be adversely affected by the operation of legacy devices (e.g., non-HEW devices) on the same channel or wireless medium. For example, because legacy devices that employ random channel access mechanisms may not be aware of scheduled grants of medium access to HEW devices, medium access contention operations performed by legacy devices may interfere with scheduled grants of medium access to HEW devices. In addition, the operation of legacy devices may be adversely affected by the operation of HEW devices on the same channel or wireless medium. For example, the scheduled grants of medium access to HEW devices may increase the likelihood of collisions during medium access contention operations performed by legacy devices. These are at least some of the technical problems to be solved by the example embodiments.

Apparatuses and methods are disclosed that may allow legacy devices that employ random channel access mechanisms to co-exist on the same wireless medium with HEW devices for which grants of medium access may be scheduled. In accordance with example embodiments, a wireless network may specify or announce periods of time during which HEW devices may access the wireless medium (e.g., according to the IEEE 802.11ax standards) without interference from legacy devices. More specifically, the example embodiments may utilize a dedicated protocol interval (DPI) during which HEW devices are allowed to access the shared wireless medium and non-HEW devices are precluded from attempting to gain access to the shared wireless medium. These and other details of the example embodiments, which provide one or more technical solutions to the aforementioned technical problems, are described in more detail below.

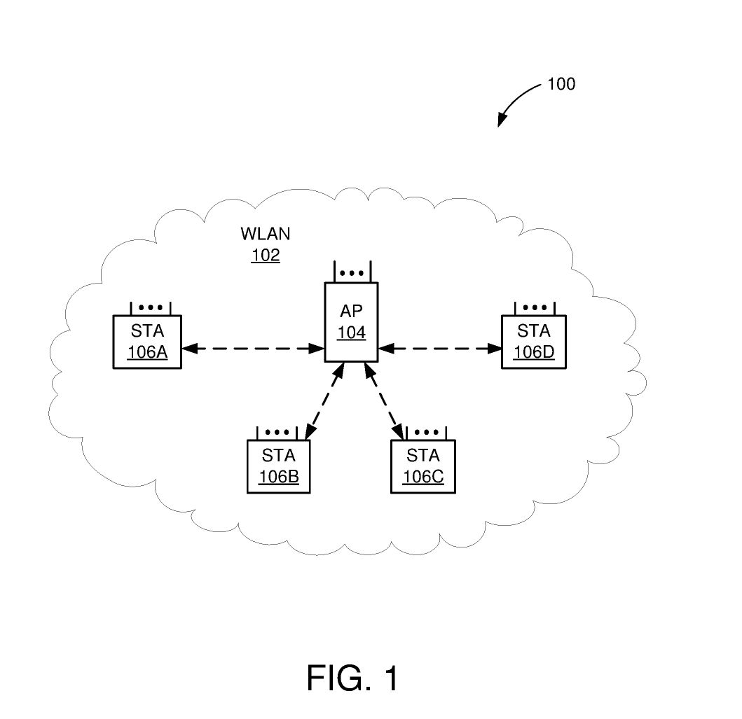

FIG. 1 is a block diagram of a wireless system 100 within which the example embodiments may be implemented. The wireless system 100 is shown to include a wireless local area network (WLAN) 102, a wireless access point (AP) 104, and four wireless stations (STAs) 106A-106D. The WLAN 102 may be formed by a plurality of Wi-Fi access points (APs) that may operate according to the IEEE 802.11 family of standards (or according to other suitable wireless protocols). Thus, although only one AP 104 is shown in FIG. 1 for simplicity, it is to be understood that WLAN 102 may be formed by any number of access points such as AP 104. The AP 104 is assigned a unique media access control (MAC) address that is programmed therein by, for example, the manufacturer of the access point. Similarly, each of STAs 106A-106D is also assigned a unique MAC address. For some embodiments, the wireless system 100 may correspond to a multiple-input multiple-output (MIMO) wireless network. Further, although the WLAN 102 is depicted in FIG. 1 as an infrastructure BSS, for other example embodiments, WLAN 102 may be an independent basic service set (IBSS), an ad-hoc network, or a peer-to-peer (P2P) network (e.g., operating according to the Wi-Fi Direct protocols).

A communication link that facilitates transmissions from the AP 104 to one or more of the STAs 106A-106D may be referred to as a downlink (DL), and a communication link that facilitates transmissions from one or more of the STAs 106A-106D to the AP 104 may be referred to as an uplink (UL). Alternatively, the downlink may be referred to as a forward link or a forward channel, and the uplink may be referred to as a reverse link or a reverse channel.

Each of STAs 106A-106D may be any suitable wireless device including, for example, a cell phone, personal digital assistant (PDA), tablet device, laptop computer, or the like. Each of STAs 106A-106D may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some embodiments, each of STAs 106A-106D may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below.

The AP 104 may be any suitable device that allows one or more wireless devices to connect to a network (e.g., a local area network (LAN), wide area network (WAN), metropolitan area network (MAN), and/or the Internet) via AP 104 using Wi-Fi, Bluetooth, or any other suitable wireless communication standards. For at least one embodiment, AP 104 may include one or more transceivers, one or more processing resources (e.g., processors and/or ASICs), one or more memory resources, and a power source. The memory resources may include a non-transitory computer-readable medium (e.g., one or more nonvolatile memory elements, such as EPROM, EEPROM, Flash memory, a hard drive, etc.) that stores instructions for performing operations described below.

For the STAs 106A-106D and/or AP 104, the one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 2.4 GHz frequency band and/or within a 5 GHz frequency band in accordance with the IEEE 802.11 specification. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz), LTE-U, and/or in accordance with other cellular protocols (e.g., a Global System for Mobile (GSM) communications protocol). In other embodiments, the transceivers included within the STA may be any technically feasible transceiver such as a ZigBee transceiver described by a specification from the ZigBee specification, a WiGig transceiver, and/or a HomePlug transceiver described a specification from the HomePlug Alliance.

The one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 2.4 GHz frequency band and/or within a 5 GHz frequency band in accordance with the IEEE 802.11 specification. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz), LTE-U, and/or in accordance with other cellular protocols (e.g., a Global System for Mobile (GSM) communications protocol).

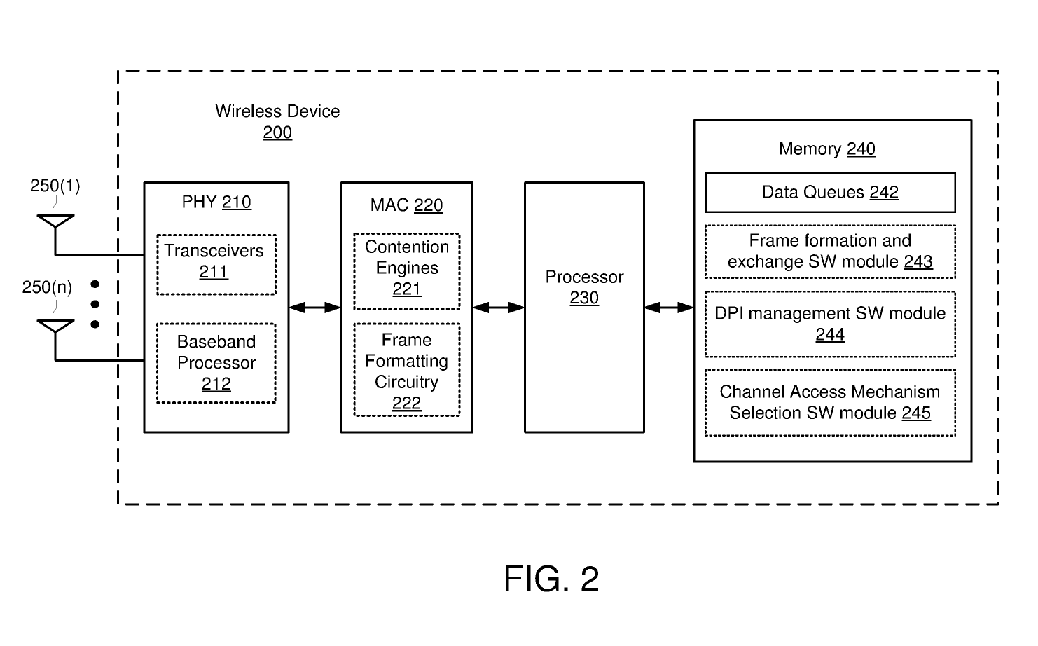

FIG. 2 shows an example wireless device 200 that may be one embodiment of any of the STAs 106A-106D of FIG. 1 and/or the AP 104 of FIG. 1. The wireless device 200 may include a physical layer device (PHY) 210, a media access control layer (MAC) 220, a processor 230, a memory 240, and a number of antennas 250(1)-250(n). The PHY 210 may include at least a number of transceivers 211 and a baseband processor 212. The transceivers 211 may be coupled to antennas 250(1)-250(n), either directly or through an antenna selection circuit (not shown for simplicity). The transceivers 211 may be used to transmit signals to and receive signals from AP 104 and/or other STAs (see also FIG. 1), and may be used to scan the surrounding environment to detect and identify nearby access points and/or other wireless devices (e.g., within wireless range of wireless device 200).

Although not shown in FIG. 2 for simplicity, the transceivers 211 may include any number of transmit chains to process and transmit signals to other wireless devices via antennas 250(1)-250(n), and may include any number of receive chains to process signals received from antennas 250(1)-250(n). Thus, for example embodiments, the wireless device 200 may be configured for MIMO operations. The MIMO operations may include single-user MIMO (SU-MIMO) operations and MU-MIMO operations. The wireless device 200 may also be configured for uplink (UL) transmissions using UL OFDMA communications and/or UL MU-MIMO communications, and may be configured to receive downlink (DL) data using OFDMA communications, MU-MIMO communications, and/or MD-AMPDUs.

The baseband processor 212 may be used to process signals received from processor 230 and/or memory 240 and to forward the processed signals to transceivers 211 for transmission via one or more of antennas 250(1)-250(n), and may be used to process signals received from one or more of antennas 250(1)-250(n) via transceivers 211 and to forward the processed signals to processor 230 and/or memory 240.

The MAC 220 may include at least a number of contention engines 221 and frame formatting circuitry 222. The contention engines 221 may contend for access to one or more shared wireless mediums, and may also store packets for transmission over the one or more shared wireless mediums. The wireless device 200 may include one or more contention engines 221 for each of a plurality of different access categories. For other embodiments, the contention engines 221 may be separate from MAC 220. For still other embodiments, the contention engines 221 may be implemented as one or more software modules (e.g., stored in memory 240 or stored in memory provided within MAC 220).

The frame formatting circuitry 222 may be used to create and/or format frames received from processor 230 and/or memory 240 (e.g., by adding MAC headers to PDUs provided by processor 230) and/or re-format frames received from PHY 210 (e.g., by stripping MAC headers from frames received from PHY 210).

Memory 240 may include a number of data queues 242. The data queues 242 may store UL data to be transmitted from wireless device 200 to one or more other wireless devices. In some aspects, the memory 240 may include one or more data queues 242 for each of a plurality of destination addresses (e.g., associated with different intended recipients of the UL data). In other aspects, the memory 240 may also include one or more data queues 242 for each of a plurality of different priority levels or access categories.

Memory 240 may also include a non-transitory computer-readable medium (e.g., one or more nonvolatile memory elements, such as EPROM, EEPROM, Flash memory, a hard drive) that may store at least the following software (SW) modules:
a frame formation and exchange software module 243 to facilitate the creation and exchange of any suitable frames (e.g., data frames, action frames, control frames, and management frames) between wireless device 200 and other wireless devices, for example, as described in more detail below;
a dedicated protocol interval (DPI) management software module 244 to create, transmit, and/or receive DPI announcement (DPIA) frames, clear-to-send (CTS) frames, dedicated CTS frames, and/or ready-to-send (RTS) frames, for example, as described in more detail below; and
a channel access mechanism selection software module 245 to select an appropriate channel access mechanism based, at least in part, on the occurrence of a dedicated protocol interval (DPI), for example, as described in more detail below.
   Each software module includes instructions that, when executed by processor 230, cause wireless device 200 to perform the corresponding functions. The non-transitory computer-readable medium of memory 240 thus includes instructions for performing all or a portion of the operations described below.

Processor 230 may be any suitable one or more processors capable of executing scripts or instructions of one or more software programs stored in wireless device 200 (e.g., within memory 240). For example, processor 230 may execute the frame formation and exchange software module 243 to facilitate the creation and exchange of any suitable frames (e.g., data frames, action frames, control frames, and management frames) between wireless device 200 and other wireless devices. Processor 230 may execute the DPI management software module 244 to facilitate the creation, transmission, and/or reception of DPIA frames, CTS frames, dedicated CTS frames, and/or RTS frames. Processor 230 may execute the channel access mechanism selection software module 245 to select an appropriate channel access mechanism based, at least in part, on the occurrence of a dedicated protocol interval (DPI).

Although not shown for simplicity, the wireless device 200 may also include a user interface. The user interface may include a keypad, a microphone, a speaker, a display, and/or any suitable element or component that conveys information to a user of the wireless device 200 and/or receives input from the user.

As described in more detail below, the example embodiments may allow access points such as AP 104 of FIG. 1 to coordinate medium access and data transmissions for a plurality of stations that may include both HEW devices and legacy devices. In some aspects, the example embodiments may leverage the ability of HEW devices to contend for medium access to coordinate the operations of HEW devices and legacy devices in a manner that ensures both HEW devices and legacy device are afforded fair access to the shared wireless medium. More specifically, for at least some implementations, a hybrid channel access mechanism may be employed that allows HEW devices to access the shared wireless medium for time periods during which legacy devices are precluded from contending for access to the shared wireless medium.

### Dedicated Clear-to-Send Frames

In some aspects, a CTS frame containing a reserved or specific MAC address may be used to allow HEW devices to access the shared wireless medium while preventing legacy devices (e.g., non-HEW devices) from contending for access to the shared wireless medium. For purposes of discussion herein, the STAs 106A and 106B of FIG. 1 may be legacy STAs, and the STAs 106C and 106D of FIG. 1 may be HEW STAs. At times when the HEW STAs 106C and 106D have queued UL data for transmission to the AP 104, it may be desirable to prevent the legacy STAs 106A and 106B from contending for medium access, for example, so that the HEW STAs 106C and 106D may transmit data to the AP 104 without interference from the legacy STAs 106A and 106B.

For example, to prevent the legacy STAs 106A and 106B from contending for medium access so that the HEW STAs 106C and 106D may transmit data to the AP 104, the AP 104 may transmit a CTS frame containing a specific MAC address in the address field. The HEW STAs 106C and 106D may be configured to interpret the specific MAC address contained in the CTS frame as an instruction to gain medium access in accordance with one or more channel access mechanisms described below. In contrast, the legacy STAs 106A and 106B may interpret the specific MAC address contained in the CTS frame as an instruction to refrain from contending for medium access for a time period. As used herein, CTS frames containing a special or specific MAC address that allows HEW devices to gain medium access while preventing legacy devices from contending for medium access may be referred to as “dedicated CTS (DCTS) frames.”

In some aspects, the specific MAC address may be a reserved address (e.g., a MAC address that is not assigned to any currently-deployed device). In this manner, the specific MAC address described herein may not be used (e.g., as a receiver address) to identify any currently-deployed wireless devices. Instead, the specific MAC address described herein may be used to announce a dedicated protocol interval (DPI) to HEW devices while preventing legacy devices from contending for medium access during the DPI.

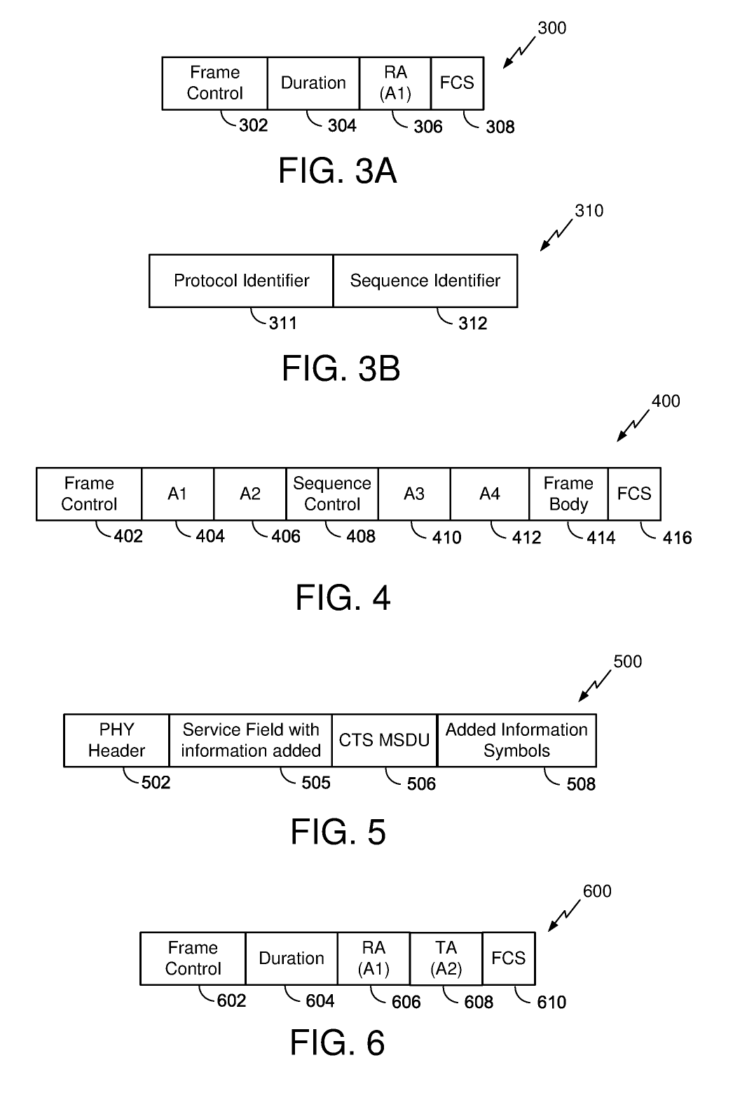

FIG. 3A illustrates an example CTS frame 300. The CTS frame 300 may be transmitted by a device to reserve a channel for communication. The CTS frame 300 is shown to include 4 different fields: a frame control (FC) field 302, a duration field 304, a receiver address (RA) field 306 (also referred to as a receiver address (a1)), and a frame check sequence (FCS) field 308. In some aspects, the fields 302, 304, 306, and 308 may have lengths of 2 bytes, 2 bytes, 6 bytes, and 4 bytes, respectively. The RA field 306 includes a full MAC address of a device, which is a 48-bit (6 octet) value.

Typically, the MAC address contained in the RA field 306 of a CTS frame indicates the device to which the CTS frame is addressed. If a device receives a CTS frame containing a MAC address that does not match the MAC address of the device, then the device typically refrains from attempting to access the wireless medium for a time period indicated in the duration field 303 of the CTS frame 300, for example, by updating its network allocation vector (NAV) according to the time period provided in the duration field 304.

In accordance with example embodiments, the RA field 306 may include a specific MAC address that HEW STAs (e.g., HEW STAs 106C and 106D of FIG. 1) may be configured to interpret as instructions not to update their respective network allocation vectors (NAVs) based on the received CTS frame 300. In this manner, the HEW STAs 106C and 106D may not be prevented from medium access based on reception of the CTS frame 300. In contrast, because the legacy STAs 106A and 106B may not recognize the specific MAC address contained in the RA field 306 of the CTS frame 300, the legacy STAs 106A and 106B may update their NAVs according to the time period indicated in the duration field 304 of the CTS frame 300, thereby preventing the legacy STAs 106A and 106B from contending for medium access during the indicated time period.

The duration field 308 of the CTS frame 300 may be set such that a predetermined percentage of a total communication time is reserved for the HEW STAs 106C and 106D to transmit data on the shared wireless medium. In this manner, access to the wireless medium may be reserved for the HEW STAs during the time period indicated in the legacy STAs' NAVs (e.g., during the dedicated protocol interval (DPI)). During the DPI, each of the HEW STAs may contend for medium access using any suitable channel access mechanism and/or may grant medium access to one or more other STAs. In some aspects, the HEW STAs may contend for medium access using a channel access mechanism that is different from those typically employed by the legacy STAs.

It is noted that the specific MAC address contained in the CTS frame 300 indicates a protocol function rather than identifying a specific receiving device. The protocol function, which may be defined by a suitable standards body, may therefore be used to convey a dedicated protocol interval (DPI), to elicit one or more actions, and/or to announce one or more specific channel access mechanisms to HEW devices while concurrently preventing legacy devices from attempting to access the wireless medium. The specific MAC address contained in the CTS frame 300 may be an individual address or a group address. When the specific MAC address is an individual address, the specific MAC address may be unique, for example, because individual MAC addresses are administered by a single authority (the Institute of Electrical and Electronics Engineers Standards Association (IEEE-SA)). Conversely, when the specific MAC address is a group address, the specific MAC address may not be unique, for example, because group addresses are not administered by a single authority but rather are free to use by any device.

In an alternative, a wireless device transmitting the CTS frame 300 including the specific MAC address may assign a specific meaning to the specific MAC address by communicating, beforehand, the meaning and the address to the associated wireless devices in a management frame exchange or via the beacon. Furthermore, some implementations may contemplate different specific MAC addresses, each assigned to a different one of the access schemes. In this manner, the specific MAC address may be utilized to demarcate the start of a special contention period for the HEW STAs.

For some implementations, a CTS frame containing DPI information may be transmitted to a specific receiver address. The specific receiver address may be a protocol identifier address indicating that a response is requested from one or more recipients of the CTS frame. For example, FIG. 3B shows an example protocol identifier address 310, in accordance with example embodiments. The protocol identifier address 310, which may be a specific MAC address as described above with respect to FIG. 3A, is shown to include a protocol identifier field 311 and a sequence identifier field 312. The protocol identifier field 311 may store a value or information specifying a communication protocol to be used during an associated DPI. The sequence identifier field 312 may store a value or information indicating the location of the corresponding CTS frame within a sequence of CTS frames. In some aspects, the protocol identifier address 310 may be 6 bytes, wherein the protocol identifier field 311 may be 5 bytes and the sequence identifier field 312 may be 1 byte. In other aspects, the protocol identifier address 310, the protocol identifier field 311, and/or the sequence identifier field 312 may be other suitable lengths.

For other implementations, the AP 104 or one of the STAs 106A-106D may transmit a frame for which the specific MAC address is located in one or more fields within the MAC header of the frame. For example, FIG. 4 illustrates an example MAC header frame 400. The MAC header frame 400 may be transmitted by a device to reserve a channel for communication. The MAC header frame 400 may include 8 fields: a frame control (FC) field 402, a receiver address A1 field 404, a receiver address A2 field 406, a sequence control field 408, a receiver address A3 field 410, a receiver address A4 field 412, a frame body field 414, and a frame check sequence (FCS) field 416.

In some aspects, the fields 402, 404, 406, 408, 410, 412, 414, and 416 of the MAC header 400 may have lengths of 2 bytes, 6 bytes, 6 bytes, 0 or 2 bytes, 6 bytes, 6 bytes, a variable number of bytes, and 4 bytes, respectively. The receiver address A1 field 404 is typically utilized for indicating the MAC address of the receiving device for the frame 400. The receiver address A2 field 406 is typically utilized for indicating the MAC address of the transmitting device of the frame 400. The receiver address A3 field 410 is typically utilized for indicating the MAC address of the source device or destination device for the frame 400. The receiver address A4 field 412 is typically utilized for indicating the MAC address of the source device or destination device of the frame 400 on a bridge link.

Similar to the implementations described in connection with FIG. 3A above, the specific MAC address may be included in any of the receiver address A1 field 404, the receiver address A2 field 406, the receiver address A3 field 410, and the receiver address A4 field. As previously described, the HEW STAs, for example STAs 106C and 106D shown in FIG. 1, are specifically configured to identify the specific MAC address in any of the above-mentioned receiver address fields as instructing the HEW STAs not to update their respective network allocation vectors (NAVs) according to a value in a duration field. Thus, the HEW STAs will not be silenced. However, because the legacy STAs, for example the STAs 106A and 106B, are not configured to identify the specific MAC address, the legacy STAs will instead be instructed to update their NAVs according to the value in the duration field. In this way, access to the wireless medium may be reserved for communication by the HEW STAs.

In some implementations, the specific MAC address additionally may be utilized to indicate that additional information is present in the frame, as described in more detail in connection with FIG. 5 below. FIG. 5 illustrates an example CTS frame 500 indicating information added to one or more fields. For example, the CTS frame 500 may include a PHY header 502, a service field 505, a CTS MAC service data unit (MSDU) 506, and optionally, a field 508. In one implementation, the inclusion of the specific MAC address in an address field of the CTS MSDU 506 may indicate, to the HEW STAs 106C and 106D of FIG. 1, that additional information is present in the CTS frame 500. For example, the additional information may be present in the service field 505. In addition, or in the alternative, the additional information may be present in field 508, after the CTS MSDU 506, in the form of one or more data symbols.

Similar to its use in CTS frames, the specific MAC address may additionally be included in a ready to send (RTS) frame. For example, FIG. 6 illustrates an example ready to send (RTS) frame 600. The RTS frame 600 includes 5 different fields: a frame control (FC) field 602, a duration field 604, a receiver address (RA) field 606 (also referred to as a receiver address (a1)), a transmitter address (TA) field 608 (also referred to as a receiver address (a2)), and a frame check sequence (FCS) field 610. In some aspects, the fields 602, 604, 606, 608, and 610 of the RTS frame 600 may have lengths of 2 bytes, 2 bytes, 6 bytes, 6 bytes, and 4 bytes, respectively. Both of the RA field 606 and the TA field 608 include a full MAC address of a device, which is a 48-bit (6 octet) value. For an RTS frame, the MAC address in the RA field 606 typically indicates the device that is to receive the RTS frame 600, while the TA field 608 typically indicates the device that transmits the RTS frame 600. In some implementations, the specific MAC address may also be included in the TA field (a2 field) 608. In such a case, the RTS frame 600 appears to have been transmitted by a device with the specific MAC address. The RA field 608 may be set to a unicast address of the receiving STA.

In an RTS/CTS exchange, the RA (a1) address of the CTS is copied from the TA (a2) address of the RTS frame 600, which implies that the specific MAC address will be copied into the CTS frame when it was present in the TA (a2) field 608 of the RTS frame 600. The presence of the specific MAC address in the TA (a2) field 608 of the RTS frame 600 may indicate a special meaning of the RTS frame 600 for the HEW STAs 106C and 106D, while the legacy STAs 106A and 106B will parse the RTS frame 600 as a regular RTS frame. In this manner, while the RTS frame and the CTS frame in the RTS/CTS exchange may be interpreted by HEW devices as permission to access the wireless medium, the RTS frame and the CTS frame in the RTS/CTS exchange may be interpreted by legacy devices as an instruction to update their respective NAVs (which as described above may cause the legacy devices to refrain from contending for medium access). The general rule is that a receiver that recognizes a specific MAC address in any one of the address fields present in a received frame parses the frame according to the rules specified for the specific MAC address (by the standard or by a peer device).

In some implementations, it may be desirable to define new control frames which carry information not present in legacy control frames, yet the new control frames are still processed by legacy wireless devices as legacy control frames would be. One such solution may include associating both a first MAC address and a second MAC address to a particular wireless device. When a frame including the first MAC address is received by the particular wireless device, the particular wireless device may process the frame according to a first standard, for example the IEEE 802.11b standards. However, when a frame including the second MAC address is received by the particular wireless device, the particular wireless device may process the frame according to a second standard, for example, the IEEE 802.11ac standards. In such a case, the frame including the second MAC address may be parsed differently than the frame including the first MAC address. In one implementation, the first MAC address may be the address provided for address resolution purposes, for example when the address is requested for using the Address Resolution Protocol (ARP). In such an implementation, the first MAC address may be used as the source address (SA) on any transmission.

In another implementation, the first MAC address may be utilized for data frames, while the second MAC address is utilized for control frames. The second MAC address may be communicated explicitly in a management frame, for example, as an information element within the management frame.

In some implementations, such a second MAC address may be derived from the first MAC address through a predefined rule. For example, the second MAC address may be formed by setting the Individual/Group (I/G) address bit of the first MAC address to 1, for example, so that the second MAC address is the group address version of the first MAC address. In another implementation, the second MAC address may be formed by setting the Universally/Locally (U/L) Administered address bit of the first MAC address to 1, for example, so that the second MAC address is the locally administered version of the first MAC address. In yet another implementation, the second MAC address may be formed by setting both the I/G bit and the U/L bit of the first MAC address to 1, for example, so that the second MAC address is the locally administered group address version of the first MAC address.

In yet another implementation, the second MAC address may be formed by flipping the least significant address bit of the first MAC address, thus indicating that the particular wireless device has two globally administered MAC addresses. In yet another implementation, the second MAC address may be formed by flipping a predetermined bit of the first MAC address. For example, the least significant address bit, or some other predetermined address bit, of the second MAC address may be set to 1, with the convention that the first MAC address always has the least significant bit, or the other predetermined address bit, set to 0. Alternatively, the second MAC address may be formed by setting the least significant address bit, or some other predetermined address bit, to 0, with the convention that the first MAC address always has the least significant bit, or the other predetermined address bit, set to 1.

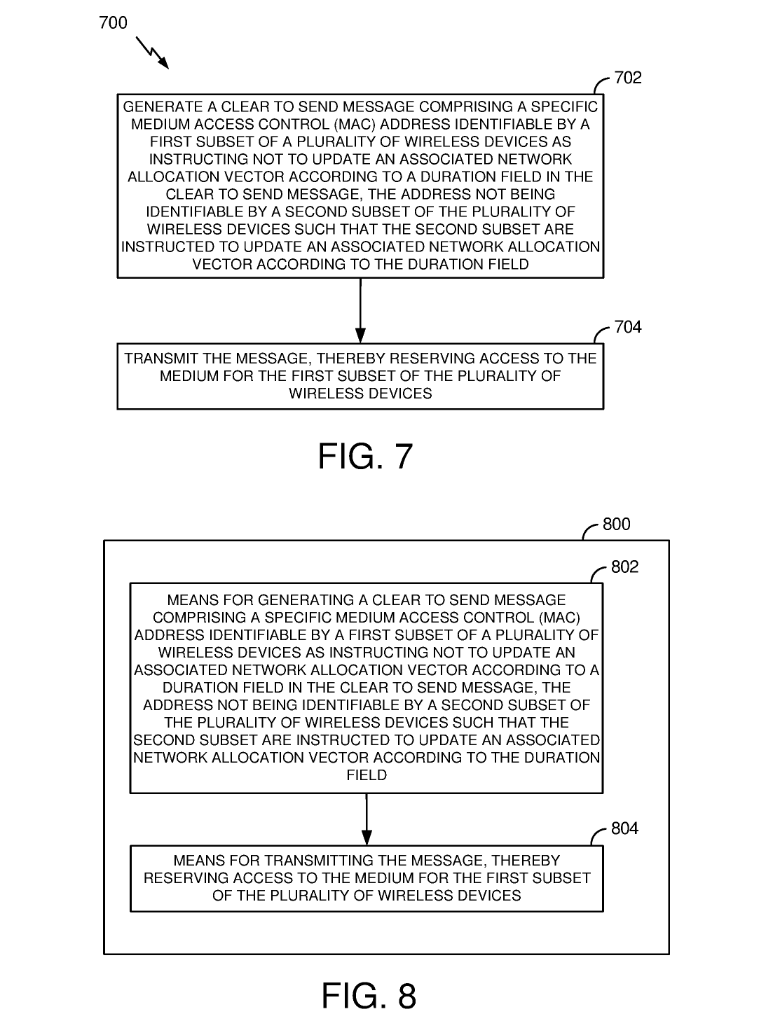

FIG. 7 is a flow chart 700 depicting an example operation for managing communications in a wireless network that includes HEW devices and legacy devices (e.g., non-HEW devices), in accordance with example embodiments. The frames may be transmitted by the AP 104 to one or more of the STAs 106A-106D shown in FIG. 1. In addition, the wireless device 200 shown in FIG. 2 may represent a more detailed view of the AP 104, as described above. Thus, in one implementation, one or more of the steps in flowchart 700 may be performed by, or in connection with, a processor and/or transmitter, such as the processor 230 and transceivers 211 of FIG. 2, although those having ordinary skill in the art will appreciate that other components may be used to implement one or more of the steps described herein. Although blocks may be described as occurring in a certain order, the blocks may be reordered, blocks may be omitted, and/or additional blocks may be added.

In operation block 702, the AP 104 or one of the STAs 106A-106D may generate a clear to send (CTS) frame including a specific medium access control (MAC) address identifiable by the HEW devices as instructing not to update an associated network allocation vector (NAV) according to a duration field in the CTS frame. Because the specific MAC address is not identifiable by the legacy devices, the legacy devices may update their respective NAVs based on the time period indicated in the duration field of the CTS frame. For example, with respect to FIG. 1, the AP 104 may generate a CTS frame including a specific MAC address such that the HEW STAs 106C and 106D may interpret the specific MAC address as an instruction to not update their respective NAVs based on the received CTS frame. Because the specific MAC address may not be recognized by the legacy STAs 106A and 106B, the legacy STAs 106A and 106B may update their respective NAVs based on the time period indicated in the duration field of the CTS frame. In such an implementation, once the CTS frame is transmitted by the AP 104 and received by the STAs 106A-106D, the legacy STAs 106A and 106B may refrain from attempting to access the wireless medium for the time period indicated in the CTS frame, thereby reserving access to the medium for the HEW STAs 106C and 106D.

In operation block 704, the AP 104 or one of STAs 106A-106D may transmit the CTS frame, thereby partially protecting reception of communications. For example, as described above, because the legacy STAs 106A and 106B update their respective NAVs in response to the CTS frame (and the HEW STAs 106C and 106D do not update their NAVs), medium access may be reserved for the HEW STAs 106C and 106D for the time period indicated in the duration field of the CTS frame (e.g., for the dedicated protocol interval).

FIG. 8 is a functional block diagram of an example device 800 that may be one embodiment of the wireless devices of FIG. 1. Those skilled in the art will appreciate that the apparatus may have more components than illustrated in FIG. 8. The apparatus 800 includes only those components useful for describing some prominent features of implementations within the scope of the claims. In one implementation, the apparatus 800 is configured to perform the example operation 700 described above with respect to FIG. 7. The apparatus 800 may include the AP 104 shown in FIG. 1, which may be shown in more detail as the wireless device 200 shown in FIG. 2.

The apparatus 800 includes means 802 for configuring transmission of a CTS frame including a specific medium access control (MAC) address identifiable by the HEW devices as instructing not to update an associated network allocation vector according to a duration field in the CTS frame, the address not being identifiable by the legacy devices such that the legacy devices are instructed to update an associated network allocation vector according to the duration field. In some implementations, the means 802 may be configured to perform one or more of the functions described above with respect to block 702 of FIG. 7. The means 802 may include at least the processor 230 shown in FIG. 2, for example.

The apparatus 800 may further include means 804 for transmitting the CTS frame, thereby partially protecting reception of communications. In some implementations, the means 804 may be configured to perform one or more of the functions described above with respect to block 704 of FIG. 7. The means 804 may include at least the transceiver 211 shown in FIG. 2, for example.

### Dedicated Protocol Interval Protection Using Dedicated CTS Frames

Referring again to FIG. 1, in various embodiments, the AP 104 and/or the STAs 106A-106D may be configured to define a dedicated protocol interval (DPI), during which only specific communications or types of communication are allowed. In various embodiments, for example, the DPI may include an interval during which no legacy transmissions are allowed. The DPI may be communicated in a DPI announcement (DPIA) frame, which may indicate one or more of: a start time of the DPI, an end time of the DPI, a length of the DPI, a periodicity of the DPI, an identification that the frame is a DPI announcement frame, a protocol indication, etc. In various embodiments, the DPI announcement may be transmitted according to the protocol of the DPI or another protocol (e.g., may be a HEW transmission including bandwidth and/or encoding not compatible with one or more legacy devices). In various embodiments, however, one or more potentially interfering STAs may not decode the DPI announcement, for example because the STA is out of range or because the STA is a legacy STA without the capability to decode the DPI announcement. Accordingly, it may be desirable to protect at least a portion of the DPI from interfering transmission. In various embodiments described herein, the dedicated CTS discussed above may be used to at least partially protect the DPI. In particular, STAs receiving the DPI announcement may transmit the dedicated CTS indicating a NAV at least partially overlapping the DPI. While DPI protection is discussed herein with respect to the dedicated CTS described above, a person having ordinary skill in the art will appreciate that other communications for wireless medium reservation may be used.

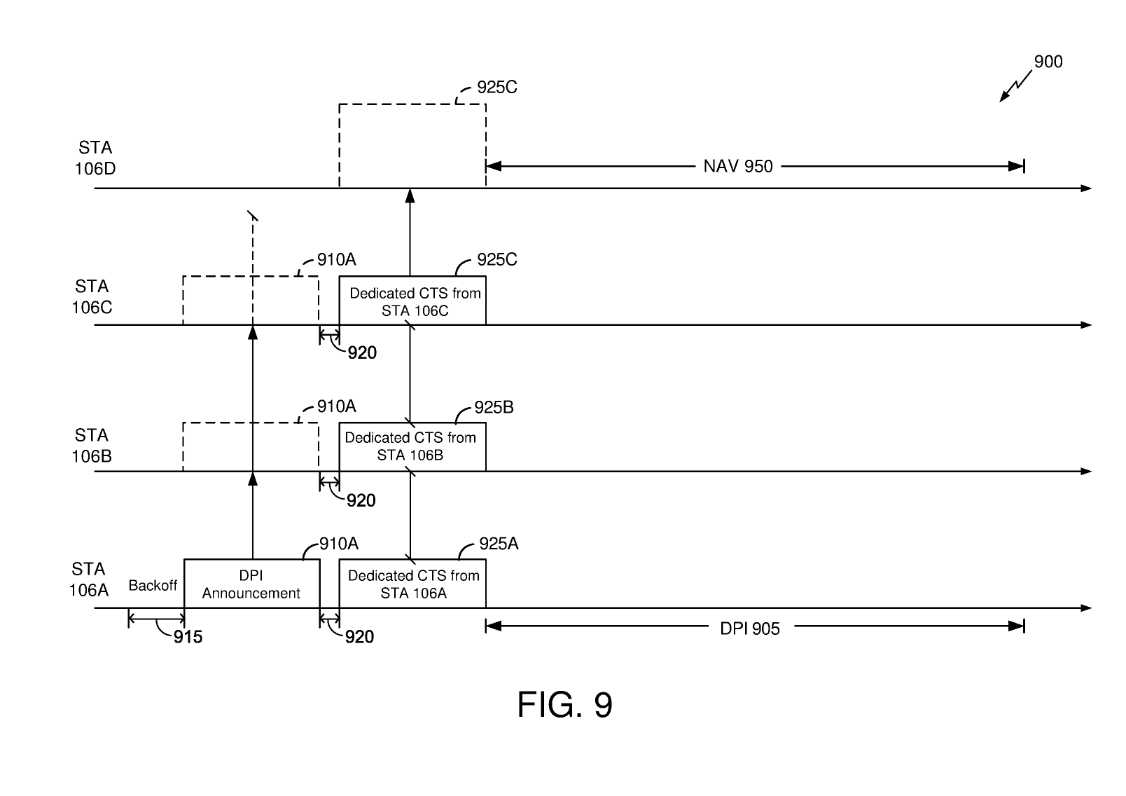

FIG. 9 is a timing diagram 900 depicting an example operation for accessing a wireless medium, in accordance with example embodiments. As shown in the timing diagram 900, communications between STAs 106A-106D progress sequentially from left to right. Each communication is shown as a line originating from a transmitter (indicated with a box) and being received by a receiver (indicated with an arrowhead). Communications that are not received are shown with a diagonal line through the communication. Although the timing diagram 900 refers to the device configuration shown in FIG. 1, other configurations are possible including omission of various devices shown or addition of other devices. For example, in various embodiments, the STA 106D may be a legacy STA and/or STAs 106A and 106B may be HEW STAs. Moreover, although the timing diagram 900 is described herein with reference to a particular order, in various embodiments, communications shown herein may be performed in a different order, or omitted, and additional communications may be added. For example, in various embodiments, one or more control frames may be added or omitted including acknowledgement (ACK) frames and/or end frames.

As shown in FIG. 9, the STA 106A determines a DPI 905. For example, the STA 106A may have data for transmission during the DPI 905. In various embodiments, such data may include a HEW protocol not detectable by legacy STAs. In some embodiments, the STA 106A may reserve the entire DPI 905 for its own transmissions. In other embodiments, the STA 106A may contend with other STAs during the DPI 905.

The STA 106A may generate a DPI announcement 910A. In an embodiment, the STA 106A contends for the wireless medium via a back-off mechanism 915 before transmitting the DPI announcement 910A. As shown in FIG. 9, the STAs 106B and 106C receive the DPI announcement 910A, whereas the STA 106D does not. In some embodiments, the STA 106D does not receive the DPI announcement 910A because it is out of range or receives an interfering signal. In some embodiments, the STA 106D does not receive the DPI announcement 910A because it is a legacy STA and not configured to decode or interpret the DPI announcement 910A. In some embodiments, the STA 106D does not receive the DPI announcement 910A because it is transmitting during transmission of the DPI announcement 910A.

The STAs 106B and 106C may determine the DPI 905 based on the DPI announcement 910A. Each of STAs 106A-106C may wait a time period 920 after the end of the DPI announcement 910A before transmitting a dedicated CTS 925A-925C indicating a NAV 950. Although the dedicated CTSs 925A-925C may be separately transmitted, they may be identical (for example, including the same predefined receiver or destination address, which may indicate to certain non-legacy devices that the NAV should not be set). Because the dedicated CTSs 925A-925C may be identical, they may be transmitted concurrently and still be decodable at devices that receive two or more dedicated CTSs 925A-925C at the same time. Such simultaneous receptions will appear to be reflections at the receiver, which commonly occurs in current wireless transmissions. In various embodiments, the time period 920 may be a distributed CTS inter-frame space (DCIFS), which in various embodiments may be as short as possible. For example, the DCIFS may be shorter than a short inter-frame space (SIFS). In other embodiments, the time period 920 may be another inter-frame space or may be omitted. In some embodiments, the predefined receiver or destination address may be associated with the DPI. In other embodiments, multiple predefined receiver or destination addresses may be associated with the DPI and the DPI may include an index that defines which of the multiple predefined receiver or destination addresses is to be used in the dedicated CTS.

As shown in FIG. 9, the STA 106D receives the dedicated CTS 925C from the STA 106C. In various embodiments, the STA 106D may decode the dedicated CTS 925C because the STA 106D is in range of the STA 106C. In various embodiments, the STA 106D may decode the dedicated CTS 925C because the dedicated CTS 925C includes a legacy frame. In various embodiments, the STA 106D may decode the dedicated CTS 925C because the STA 106D is not transmitting during transmission of the dedicated CTS 925C. In various embodiments, the STA 106D may receive a plurality of the dedicated CTSs 925A-925C, but may interpret them as a single dedicated CTS (or reflections thereof).

Referring still to FIG. 9, the STA 106D sets the NAV 950 based on the dedicated CTS 925C. In various embodiments, the NAV 950 may include the duration of the DPI 905. For example, the NAV 950 may start and end at the same time as the DPI 905. In some embodiments, the NAV 950 may be longer then the DPI 905. In some embodiments, the NAV 950 may only partially overlap with the DPI 905. In various embodiments, the STAs 106A-106C may be in range of the dedicated CTSs 925A-925C, but may not decode the dedicated CTSs 925A-925C during concurrent transmission.

In some embodiments, the STA 106D may not set the NAV 950 as described herein. For example, the STA 106D may be a HEW STA capable of communicating during the DPI 905. In some embodiments, the NAV 950 may indicate the DPI 905. Accordingly, the STA 106D may contend for transmission during the DPI 905. In various embodiments where the STA 106D participates during the DPI 905, the STA 106D may transmit its own dedicated CTS setting the NAV 950 prior to participating.

The STAs 106A-106C, after transmitting the dedicated CTSs 925A-925C, may participate in the DPI 905 according to the DPI announcement 910A. In some embodiments, for example, the STAs 106A-106C may contend for transmission during the DPI 905. In other embodiments, the DPI announcement 910A may reserve the DPI 905 for the STA 106A and the STAs 106B and 106C may refrain from transmitting during the DPI 905. In various other embodiments, the DPI announcement 910A may define the DPI 905 for one or more particular transmissions, transmitting devices, and/or classes or types of transmissions.

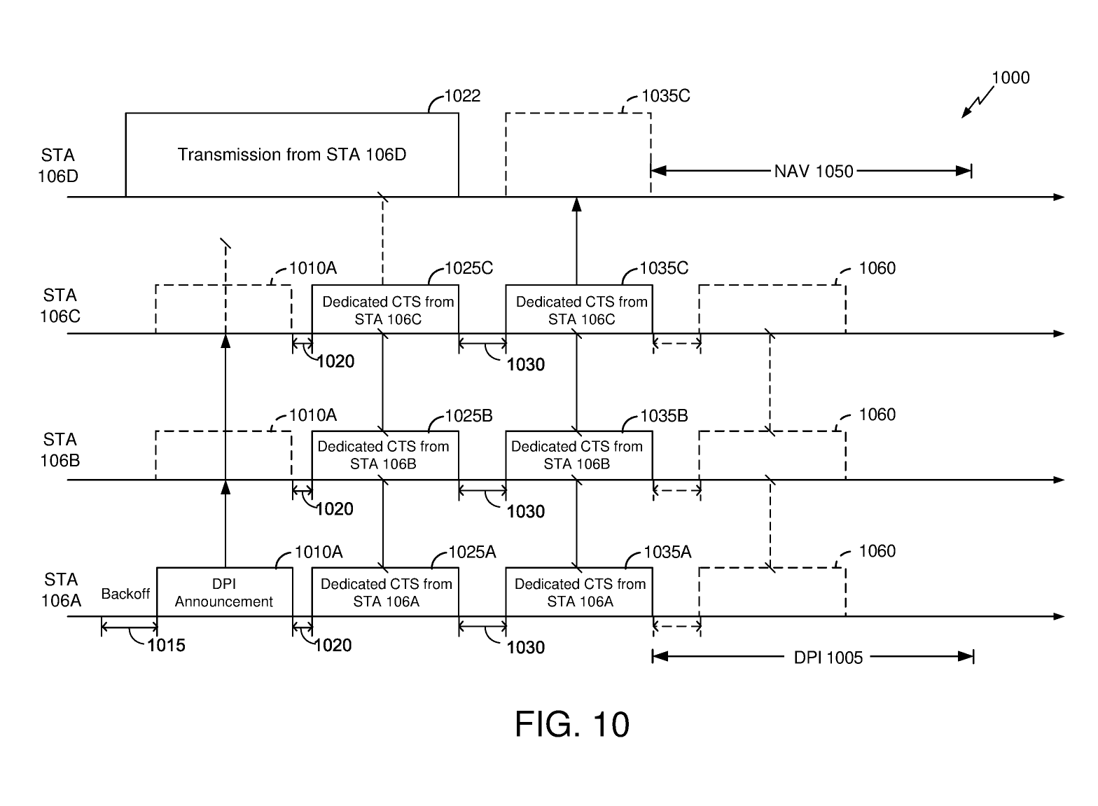

As shown in FIG. 9, the STA 106D receives the dedicated CTS 925C from the STA 106C. In some embodiments, however, the STA 106D may not receive the dedicated CTS 925C. In some embodiments, the STA 106D does not receive the dedicated CTS 925C because of another interfering transmission during transmission of the dedicated CTS 925C. In some embodiments, the STA 106D does not receive the dedicated CTS 925C because it is transmitting during transmission of the dedicated CTS 925C, as shown below in FIG. 10.

FIG. 10 is a timing diagram 1000 depicting another example operation for accessing a wireless medium, in accordance with example embodiments. As shown in the timing diagram 1000, communications between STAs 106A-106D progress sequentially from left to right. Each communication is shown as a line originating from a transmitter (indicated with a box) and being received by a receiver (indicated with an arrowhead). Communications that are not received are shown with a diagonal line through the communication. Although the timing diagram 1000 refers to the device configuration shown in FIG. 1, other configurations are possible including omission of various devices shown or addition of other devices. For example, in various embodiments, the STA 106D may be a legacy STA and/or STAs 106A and 106B may be HEW STAs. Moreover, although the timing diagram 1000 is described herein with reference to a particular order, in various embodiments, communications shown herein may be performed in a different order, or omitted, and additional communications may be added. For example, in various embodiments, one or more control frames may be added or omitted including acknowledgement (ACK) frames and/or end frames.

As shown in FIG. 10, the STA 106A determines a DPI 1005. For example, the STA 106A may have data for transmission during the DPI 1005. In various embodiments, such data may include a HEW protocol not detectable by legacy STAs. In some embodiments, the STA 106A may reserve the entire DPI 1005 for its own transmissions. In other embodiments, the STA 106A may contend with other STAs during the DPI 1005.

The STA 106A may generate a DPI announcement 1010A. In an embodiment, the STA 106A contends for the wireless medium via a back-off mechanism 1015 before transmitting the DPI announcement 1010A. As shown in FIG. 10, the STAs 106B and 106C receive the DPI announcement 1010A, whereas the STA 106D does not. In the illustrated embodiment, the STA 106D does not receive the DPI announcement 1010A because it is transmitting a communication 1022 during transmission of the DPI announcement 1010A. In some embodiments, the STA 106D does not receive the DPI announcement 1010A because it is out of range or receives an interfering signal. In some embodiments, the STA 106D does not receive the DPI announcement 1010A because it is a legacy STA and not configured to decode or interpret the DPI announcement.

The STAs 106B and 106C may determine the DPI 1005 based on the DPI announcement 1010A. Each STA 106A-106C may wait a time period 1020 after the end of the DPI announcement 1010A before transmitting a respective one of dedicated CTS frames 1025A-1025C indicating a NAV 1050. Although the dedicated CTS frames 1025A-1025C may be separately transmitted, they may be identical (for example, including the same predefined destination address, which may indicate to certain non-legacy devices that the NAV should not be set). In various embodiments, the time period 1020 may include a distributed coordination function inter-frame space (DCIFS), which in various embodiments may be as short as possible. For example, the DCIFS may be shorter than a short inter-frame space (SIFS). In other embodiments, the time period 1020 may be another inter-frame space or may be omitted.

As shown, the STA 106D does not receive the dedicated CTS frames 1025A-1025C because it is transmitting the communication 1022 during transmission of dedicated CTS frames 1025A-1025C. In some embodiments, the STA 106D does not receive the dedicated CTS frames 1025A-1025C because it is out of range or receives an interfering signal. Accordingly, it may be desirable for the STAs 106A-106C to transmit one or more additional dedicated CTS frames, thereby increasing the chances of reaching nearby STAs and protecting the DPI 1005.

Each STA 106A-106C may wait a time period 1030 after the end of the dedicated CTS frames 1025A-1025C before transmitting additional dedicated CTS frames 1035A-1035C indicating the NAV 1050. Although the dedicated CTS frames 1035A-1035C may be separately transmitted, they may be identical (for example, including the same predefined destination address, which may indicate to certain non-legacy devices that the NAV should not be set). In various embodiments, the time period 1030 may include a contention window inter-frame space (CIFS). In other embodiments, the time period 1030 may be another inter-frame space or may be omitted.

As shown in FIG. 10, the STA 106D receives the dedicated CTS frame 1035C from the STA 106C. In the illustrated embodiment, the STA 106D may decode the dedicated CTS frame 1035C because the STA 106D is no longer transmitting the communication 1022. In various embodiments, the STA 106D may decode the dedicated CTS frame 1035C because the STA 106D is in range of the STA 106C. In various embodiments, the STA 106D may receive a plurality of the dedicated CTS frames 1035A-1035C, but may interpret them as a single dedicated CTS frame (or echoes thereof).

Referring still to FIG. 10, the STA 106D sets the NAV 1050 based on the dedicated CTS frame 1035C. In various embodiments, the NAV 1050 may include the duration of the DPI 1005. For example, the NAV 1050 may start and end at the same time as the DPI 1005. In some embodiments, the NAV 1050 may be longer then the DPI 1005. In some embodiments, the NAV 1050 may only partially overlap with the DPI 1005. In various embodiments, the STAs 106A-106C may be in range of the dedicated CTS frames 1035A-1035C, but may not decode the dedicated CTS frames 1035A-1035C during concurrent transmission.

In some embodiments, the STA 106D may not set the NAV 1050 as described herein. For example, the STA 106D may be a HEW STA capable of communicating during the DPI 1005. In some embodiments, the NAV 1050 may indicate the DPI 1005. Accordingly, the STA 106D may contend for transmission during the DPI 1005. In various embodiments where the STA 106D participates during the DPI 1005, the STA 106D may transmit its own dedicated CTS setting the NAV 1050 prior to participating.

In various embodiments, the STAs 106A-106C may transmit one or more additional CTS frames 1060. For example, the STAs 106A-106C may again wait a predetermined or dynamically determined amount of time after the end of the dedicated CTS frames 1035A-1035C before transmitting one or more additional dedicated CTS frame 1060 indicating the NAV 1050. In various embodiments, the time may include a contention window inter-frame space (CIFS). In other embodiments, the time may be another inter-frame space or may be omitted. In some examples of determining the number of times to retransmit CTS frames 1060, one or more reserved receiver addresses of the CTS frames 1060 may include a sequence identifier value indicating a remaining number of times to retransmit dedicated CTS frames 1060. As such, the number of times indicated may be decremented for each transmission of the CTS frames 1060 (or alternatively, e.g., be incremented until a predefined maximum limit is reached for transmission).

The STAs 106A-106C, after transmitting the dedicated CTS frames 1035A-1035C, may participate in the DPI 1005 according to the DPI announcement 1010A. In some embodiments, for example, the STAs 106A-106C may contend for transmission during the DPI 1005. In other embodiments, the DPI announcement 1010A may reserve the DPI 1005 for the STA 106A and the STAs 106B and 106C may refrain from transmitting during the DPI 1005. In various other embodiments, the DPI announcement 1010A may define the DPI 1005 for one or more particular transmissions, transmitting devices, and/or classes or types of transmissions.

As shown in FIGS. 9-10, the STAs 106A-106C may coordinate transmission of dedicated CTSs via a DPI announcement frame. In various embodiments, transmission of dedicated CTSs may be coordinated in other ways. For example, when the STAs 106A-106C are time synchronized, as shown below in FIG. 10, dedicated CTSs may be scheduled in advance.

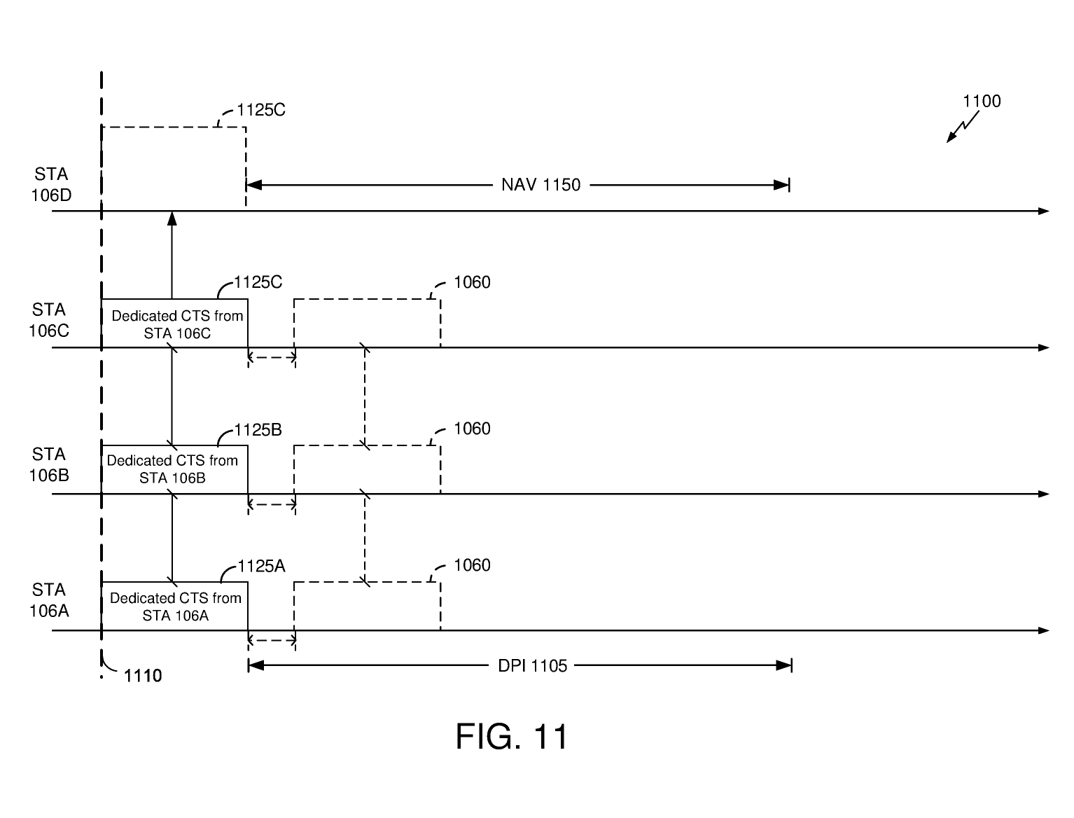

FIG. 11 is a timing diagram 1100 depicting yet another example operation for accessing a wireless medium, in accordance with example embodiments. As shown in the timing diagram 1100, communications between time-synchronized STAs 106A-106D progress sequentially from left to right. Each communication is shown as a line originating from a transmitter (indicated with a box) and being received by a receiver (indicated with an arrowhead). Communications that are not received are shown with a diagonal line through the communication. Although the timing diagram 1100 refers to the device configuration shown in FIG. 1, other configurations are possible including omission of various devices shown or addition of other devices. For example, in various embodiments, the STA 106D may be a legacy STA and/or STAs 106A and 106B may be HEW STAs. Moreover, although the timing diagram 1100 is described herein with reference to a particular order, in various embodiments, communications shown herein may be performed in a different order, or omitted, and additional communications may be added. For example, in various embodiments, one or more control frames may be added or omitted including acknowledgement (ACK) frames and/or end frames.

As shown in FIG. 11, the time synchronized STAs 106A-106C may determine a DPI 1105. For example, a start time of the DPI 1105 may be pre-stored, dynamically determined, or otherwise coordinated in advance. In various embodiments, the STAs 106A-106C may contend with each other during the DPI 1105. In other embodiments, the STAs 106A-106C may coordinate usage of the DPI 1105 using transmission slots, alternating access, etc.

The STAs 106A-106C may also determine a synchronized time 1110 for transmission of dedicated CTS frames 1125A-1125C indicating a NAV 1150. Although the dedicated CTS frames 1125A-1125C may be separately transmitted, they may be identical (for example, including the same predefined destination address, which may indicate to certain non-legacy devices that the NAV should not be set). In various embodiments, the time 1110 may include one or more scheduled dedicated CTS frame transmission times.

As shown, the STA 106D does not receive the dedicated CTS frames 1125A-1125C. In some embodiments, the STA 106D does not receive the dedicated CTS frames 1125A-925C because it is out of range or receives an interfering signal. Accordingly, it may be desirable for the STAs 106A-106C to transmit one or more additional dedicated CTS frames, thereby increasing the chances of reaching nearby STAs and protecting the DPI 1105.

As shown in FIG. 11, the STA 106D receives the dedicated CTS frame 1125C from the STA 106C. In the illustrated embodiment, the legacy STA 106D may decode the dedicated CTS frame 1125C because the dedicated CTS frame 1125C has a legacy format. In various embodiments, the STA 106D may decode the dedicated CTS frame 1125C because the STA 106D is in range of the STA 106C. In various embodiments, the STA 106D may receive a plurality of the dedicated CTS frames 1135A-1135C, but may interpret them as a single dedicated CTS frame (or echoes thereof).

Referring still to FIG. 11, the STA 106D sets the NAV 1150 based on the dedicated CTS frame 1125C. In various embodiments, the NAV 1150 may include the duration of the DPI 1105. For example, the NAV 1150 may start and end at the same time as the DPI 1105. In some embodiments, the NAV 1150 may be longer then the DPI 1105. In some embodiments, the NAV 1150 may only partially overlap with the DPI 1105. In various embodiments, the STAs 106A-106C may be in range of the dedicated CTS frames 1125A-1125C, but may not decode the dedicated CTS frames 1125A-1125C during concurrent transmission.

In some embodiments, the STA 106D may not set the NAV 1150 as described herein. For example, the STA 106D may be a HEW STA capable of communicating during the DPI 1105. In some embodiments, the NAV 1150 may indicate the DPI 1105. Accordingly, the STA 106D may contend for transmission during the DPI 1105. In various embodiments where the STA 106D participates during the DPI 1105, the STA 106D may transmit its own dedicated CTS frame setting the NAV 1150 prior to participating.

In various embodiments, the STAs 106A-106C may transmit one or more additional CTS frames 106C. For example, the STAs 106A-106C may wait a time period after the end of the dedicated CTS frames 1125A-1125C before transmitting one or more additional dedicated CTS frames 1060 indicating the NAV 1150. In various embodiments, the time period may include a contention window inter-frame space (CIFS). In other embodiments, the time period may be another inter-frame space or may be omitted.

The STAs 106A-106C, after transmitting the dedicated CTS frames 1125A-1125C, may participate in the DPI 1105 according to the DPI announcement 1110A. In some embodiments, for example, the STAs 106A-106C may contend for transmission during the DPI 1105. In other embodiments, a previously transmitted DPI announcement (not shown) may reserve the DPI 1105 for the STA 106A, and the STAs 106B-106C may refrain from transmitting during the DPI 1105. In various other embodiments, the DPI announcement may define the DPI 1105 for one or more particular transmissions, transmitting devices, and/or classes or types of transmissions.

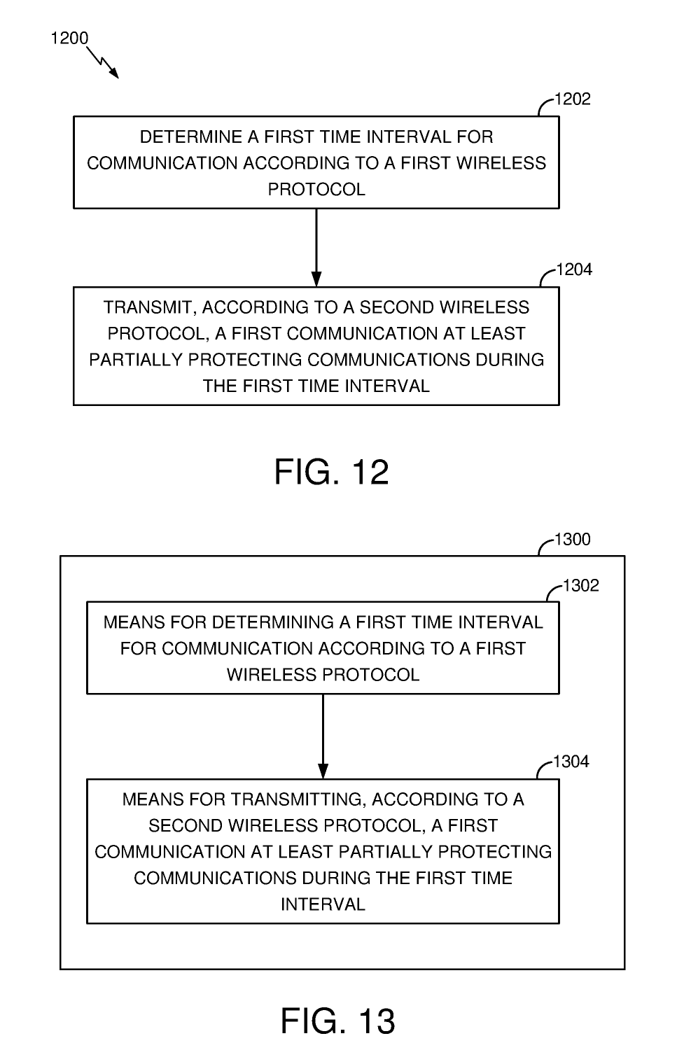

FIG. 12 is a flowchart 1200 depicting an example operation for managing communications in a wireless network that includes HEW devices and legacy devices (e.g., non-HEW devices), in accordance with example embodiments. Although the flowchart 1200 is described herein with reference to the wireless communication system 100 discussed above with respect to FIG. 1, the wireless device 200 discussed above with respect to FIG. 2, and the timing diagrams 900, 1000, and 1100 discussed above with respect to FIGS. 9-11, respectively, a person having ordinary skill in the art will appreciate that the method of flowchart 1200 may be implemented by another device described herein, any other suitable device, or any combination of multiple devices. In an embodiment, one or more steps in flowchart 1200 may be performed by a processor or controller. Although the method of flowchart 1200 is described herein with reference to a particular order, in various embodiments, blocks herein may be performed in a different order, or omitted, and additional blocks may be added.

First, at block 1202, the wireless device 200 determines a first time interval for communication according to a HEW protocol. For example, any of the STAs 106A-106D may determine the DPI 905, 1005, and/or 1105. In various embodiments, the HEW protocol may include a HEW protocol. In various embodiments, the HEW protocol is not decodable by one or more legacy devices.

Next, at block 1204, the wireless device 200 transmits, according to a legacy protocol, a first communication at least partially protecting reception of communications during the first time interval. For example, any of the STAs 106A-106D may transmit the dedicated CTS frames 925A-925C, 1025A-1025C, and/or 1025A-1025C. The dedicated CTS frames 925A-925C, 1025A-1025C, and/or 1125A-1125C may indicate the NAVs 950, 1050, and/or 1150.

In various embodiments, the wireless device 200 may further be configured to wait for a second time interval before retransmitting the first communication. For example, any of the STAs 106A-106D may wait for the time period 1030 before transmitting the dedicated CTS frames 1035A-1035C, 1060, 1160. In various embodiments, the second time interval may include a contention window inter-frame space (CIFS).

In various embodiments, the wireless device 200 may be configured to transmit a second communication, according to the legacy protocol, during the first time interval. For example, any of the STAs 106A-106D may contend for transmission during the DPI 905, 1005, and/or 1105. In some embodiments, only one STA 106A may transmit during the DPI 905, 1005, and/or 1105.

In various embodiments, the wireless device 200 may be configured transmit a second communication announcing the first communication. The wireless device may wait for a second time interval, after transmitting the second communication, before transmitting the first communication. For example, the STA 106A may transmit the DPI announcement 1010A and may wait for the time period 1020 before transmitting the dedicated CTS frame 1025A. In an embodiment, the wireless device 200 may contend for medium access during a back-off period 1015 before transmitting the DPI announcement 1010A. In various embodiments, the second time interval may be shorter than a short inter-frame space (SIFS).

In various embodiments, the wireless device 200 may be configured to at least partially synchronize a clock with at least one other wireless device and to wait for a synchronized transmission time before transmitting the first communication. For example, any of the STAs 106A-106D may synchronize their clocks with each other and may wait for the time period 1110 before transmitting the dedicated CTS frames 1125A-1125C.

In various embodiments, the second communication may include a CTS frame including a specific medium access control (MAC) address identifiable by the HEW devices as instructing not to update an associated network allocation vector according to a duration field in the CTS frame, the address not being identifiable by the legacy devices such that the legacy devices are instructed to update an associated network allocation vector according to the duration field. For example, the dedicated CTS frames 925A-925C, 1025A-10250, 1035A-10350, 1060, 1125A-11250, 1135A-1135C, and/or 1160 may include any of the dedicated CTS frames described above with respect to FIGS. 3-8.

FIG. 13 is a functional block diagram of an apparatus 1300 that may be one embodiment of the wireless devices of FIG. 1. Those skilled in the art will appreciate that an apparatus for detecting wireless communication may have more components than the simplified apparatus 1300 shown in FIG. 13. The apparatus 1300 for wireless communication in an IEEE 802.11 wireless communication system including legacy and high-efficiency wireless (HEW) devices shown includes only those components useful for describing some prominent features of implementations within the scope of the claims. The apparatus 1300 for wireless communication in an IEEE 802.11 wireless communication system including legacy and high-efficiency wireless (HEW) devices includes means 1302 for determining a first time interval for communication according to a HEW protocol, and means 1304 for transmitting, according to a legacy protocol, a first communication at least partially protecting reception of communications during the first time interval. In various embodiments, the apparatus 1300 may further include means for performing any other block or function described herein.

In an embodiment, means 1302 for determining a first time interval for communication according to a HEW protocol may be configured to perform one or more of the functions described above with respect to block 1202 (FIG. 12). In various embodiments, means 1302 for determining a first time interval for communication according to a HEW protocol may be implemented by one or more of the processor 230 (FIG. 2), the memory 240 (FIG. 2), the PHY 210 (FIG. 2), and/or the antennas 250(1)-250(n) (FIG. 2).

In an embodiment, means 1304 for transmitting, according to a legacy protocol, a first communication at least partially protecting reception of communications during the first time interval may be configured to perform one or more of the functions described above with respect to block 1204 (FIG. 12). In various embodiments, means 1304 for transmitting, according to a legacy protocol, a first communication at least partially protecting reception of communications during the first time interval may be implemented by one or more of the processor 230 (FIG. 2), the memory 240 (FIG. 2), the PHY 210 (FIG. 2), and/or the antennas 250(1)-250(n) (FIG. 2).

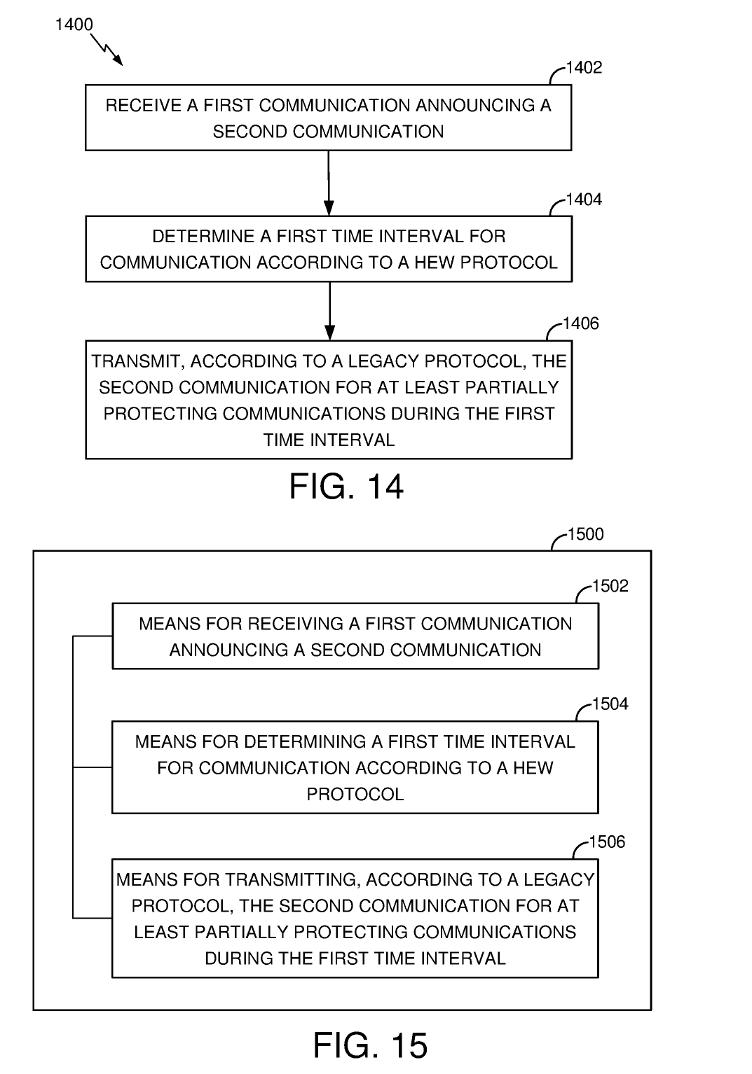

FIG. 14 is a flowchart 1400 depicting an example operation for managing communications in a wireless network that includes HEW devices and legacy devices (e.g., non-HEW devices), in accordance with example embodiments. Although the method of flowchart 1400 is described herein with reference to the wireless communication system 100 discussed above with respect to FIG. 1, the wireless device 200 discussed above with respect to FIG. 2, and the timing diagrams 900, 1000, and 1100 discussed above with respect to FIGS. 9-11, respectively, a person having ordinary skill in the art will appreciate that the method of flowchart 1400 may be implemented by another device described herein, any other suitable device, or any combination of multiple devices. In an embodiment, one or more steps in flowchart 1400 can be performed by a processor or controller. Although the method of flowchart 1400 is described herein with reference to a particular order, in various embodiments, blocks herein can be performed in a different order, or omitted, and additional blocks can be added.

First, at block 1402, the wireless device 200 receives a first communication announcing a second communication. For example, the STA 106C can receive the DPI announcement 1010A. In various embodiments, the wireless device 200 can wait for a second time interval, after receiving the first communication, before transmitting the second communication. For example, the STA 106C can wait for the time period 1020 before transmitting the dedicated CTS frame 1025A.

Next, at block 1404, the wireless device 200 determines a first time interval for communication according to a HEW protocol. For example, any of the STAs 106A-106D can determine the DPI 905, 1005, and/or 1105. In various embodiments, the HEW protocol can include a HEW protocol. In various embodiments, the HEW protocol is not decodable by one or more legacy devices.

Then, at block 1406, the wireless device 200 transmits, according to a legacy protocol, the second communication for at least partially protecting reception of communications during the first time interval. For example, any of the STAs 106A-106D can transmit the dedicated CTS frames 925A-925C, 1025A-1025C, and/or 1025A-1025C. The dedicated CTS frames 925A-925C, 1025A-1025C, and/or 1125A-1125C may indicate the NAVs 950, 1050, and/or 1150.

In various embodiments, the wireless device 200 can further be configured to wait for a second time interval before retransmitting the second communication. For example, any of the STAs 106A-106D can wait for the time period 1030 before transmitting the dedicated CTS frames 1035A-1035C, 1060, 1160. In various embodiments, the second time interval can include a contention window inter-frame space (CIFS).

In various embodiments, the wireless device 200 can be configured to transmit a third communication, according to the legacy protocol, during the first time interval. For example, any of the STAs 106A-106D can contend for transmission during the DPI 905, 1005, and/or 1105. In some embodiments, only one STA 106A can transmit during the DPI 905, 1005, and/or 1105.

In various embodiments, the second communication can include a CTS frame including a specific medium access control (MAC) address identifiable by the HEW devices as instructing not to update an associated network allocation vector according to a duration field in the CTS frame, the address not being identifiable by the legacy devices such that the legacy devices are instructed to update an associated network allocation vector according to the duration field. For example, the dedicated CTS frames 925A-925C, 1025A-10250, 1035A-10350, 1060, 1125A-11250, 1135A-1135C, and/or 1160 can include any of the dedicated CTS frames described above with respect to FIGS. 3-8.

FIG. 15 is a functional block diagram of another apparatus 1500 that may be one embodiment of the wireless devices of FIG. 1. Those skilled in the art will appreciate that an apparatus for detecting wireless communication can have more components than the simplified apparatus 1500 shown in FIG. 15. The apparatus 1500 for wireless communication in an IEEE 802.11 wireless communication system including legacy and high-efficiency wireless (HEW) devices shown includes only those components useful for describing some prominent features of implementations within the scope of the claims. The apparatus 1500 for wireless communication in an IEEE 802.11 wireless communication system including legacy and high-efficiency wireless (HEW) devices includes means 1502 for receiving a first communication announcing a second communication, means 1504 for determining a first time interval for communication according to a HEW protocol, and means 1506 for transmitting, according to a legacy protocol, the second communication for at least partially protecting reception of communications during the first time interval. In various embodiments, the apparatus 1500 can further include means for performing any other block or function described herein.

In an embodiment, means 1502 for receiving a first communication announcing a second communication can be configured to perform one or more of the functions described above with respect to block 1402 (FIG. 14). In various embodiments, means 1502 for receiving a first communication announcing a second communication can be implemented by one or more of the processor 230 (FIG. 2), the memory 240 (FIG. 2), the PHY 210 (FIG. 2), and/or the antennas 250(1)-250(n) (FIG. 2).

In an embodiment, means 1504 for determining a first time interval for communication according to a HEW protocol can be configured to perform one or more of the functions described above with respect to block 1404 (FIG. 14). In various embodiments, means 1502 for determining a first time interval for communication according to a HEW protocol may be implemented by one or more of the processor 230 (FIG. 2), the memory 240 (FIG. 2), the PHY 210 (FIG. 2), and/or the antennas 250(1)-250(n) (FIG. 2).

In an embodiment, means 1506 for transmitting, according to a legacy protocol, the second communication for at least partially protecting reception of communications during the first time interval may be configured to perform one or more of the functions described above with respect to block 1404 (FIG. 14). In various embodiments, means 1506 for transmitting, according to a legacy protocol, the second communication for at least partially protecting reception of communications during the first time interval may be implemented by one or more of the processor 230 (FIG. 2), the memory 240 (FIG. 2), the PHY 210 (FIG. 2), and/or the antennas 250(1)-250(n) (FIG. 2).

As described above, a dedicated protocol interval (DPI) selected by one wireless device may be announced to one or more other wireless devices by transmitting a DPI announcement (DPIA) frame to the one or more other wireless devices. The DPIA frame may indicate a start time of the DPI, an end time of the DPI, a duration of the DPI, a periodicity of the DPI, and/or a communication protocol to be used for data transmissions during the DPI. In some aspects, the DPIA frame may be a CTS frame (e.g., CTS frame 300 of FIG. 3A) transmitted according to one or more legacy communication protocols, for example, so that legacy devices are able to receive and decode information announcing the occurrence and parameters of the DPI.

Referring again to FIGS. 3A and 3B, a STA may receive a DPIA transmitted as a CTS frame 300 containing a protocol identifier address 310. The STA may decode the CTS frame 300 to learn of an upcoming DPI, and may determine the protocol specified for the upcoming DPI based on the value stored in the protocol identifier field 311 of the protocol identifier address 310. The STA may also examine the value stored in the sequence identifier field 312 of the protocol identifier address 310 to determine whether the STA is to transmit one or more CTS frames 300 to other devices.

For example, if the sequence identifier value is less than a maximum value, then the STA may transmit a dedicated CTS frame 300 after a suitable time period (e.g., after a DCIFS duration). In some aspects, the dedicated CTS frame 300 transmitted by the STA may contain a protocol identifier address 310 that includes the protocol identifier value indicated by the DPIA frame and an incremented sequence identifier value. Transmission of the dedicated CTS frame 300 from the STA may trigger other STAs to transmit additional dedicated CTS frames until the maximum value is reached. Conversely, if the sequence identifier value is greater than the maximum value, then the STA may not transmit additional CTS frames. It is noted that when a transmitted CTS frame contains a protocol identifier address, it may be important to reserve the range of MAC addresses that may be used for protocol identifier address values.

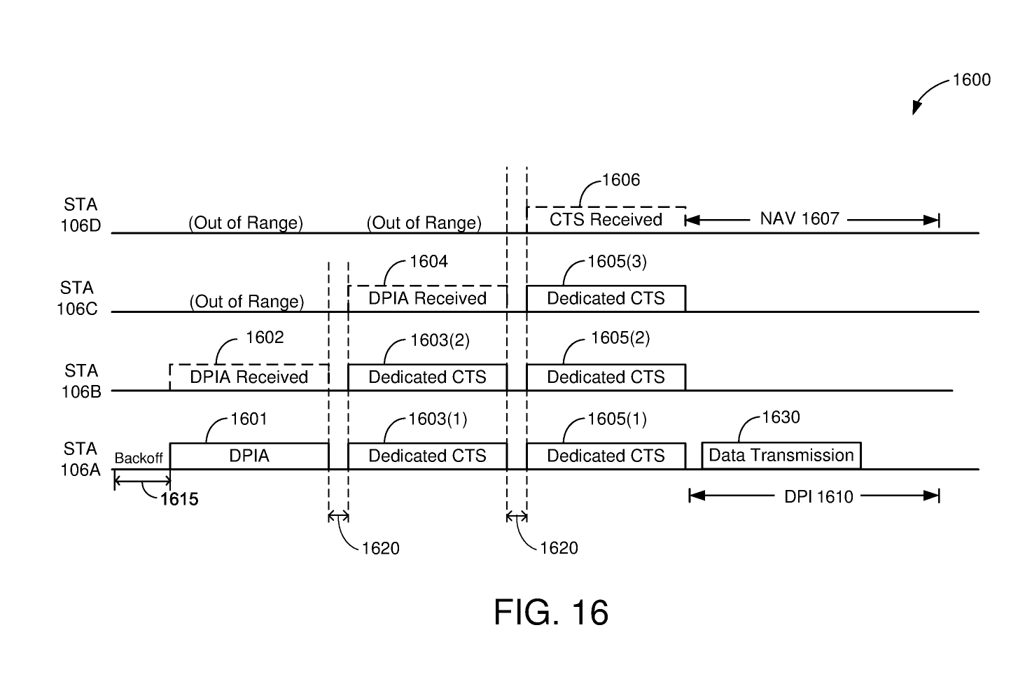

FIG. 16 is a timing diagram 1600 depicting an example coordination of a dedicated protocol interval (DPI), in accordance with example embodiments. STA 106A may contend for medium access, and after a back-off period 1605, may transmit a DPIA frame 1601. DPIA frame 1601 may be a CTS frame containing a protocol identifier address including a protocol identifier value denoted as “Pi” and a sequence identifier value denoted as “Si.” STAs 106C-106D may be out of range of STA 106A, and therefore may not receive DPIA frame 1601. STA 106B may receive the DPIA frame 1602.

STAs 106A-106B may determine that the sequence identifier value Si is less than the maximum value. After a time period 1620 (which may be a DCIFS duration), STA 106A may transmit a first dedicated CTS frame 1603(1), and STA 106B may transmit a first dedicated CTS frame 1603(2). Each of the first dedicated CTS frames 1603(1) and 1603(2) may contain a protocol identifier address including a protocol identifier value of Pi and a sequence identifier value of (Si+1). STA 106C may receive one or more of the first dedicated CTS frames 1604. STA 106D may not receive any of the first dedicated CTS frames 1603(1) and 1603(2), for example, because STA 106D may be out of range of STAs 106A-106B or may be a legacy STA (wherein, e.g., STAs 106A-106B may be HEW STAs).

STAs 106A-106C may determine that the sequence identifier value (Si+1) is less than the maximum value. After a time period 1620 (which may be a DCIFS duration), STAs 106A-106C may transmit respective second dedicated CTS frames 1605(1)-1605(3). Each of the second dedicated CTS frames 1605(1)-1605(3) may contain a protocol identifier address including a protocol identifier value of Pi and a sequence identifier value of (Si+2). STA 106D may receive one or more of the second dedicated CTS frames 1606. After receiving one or more of the dedicated CTS frames, STA 106D may set its NAV 1607 to the indicated duration of the DPI, and thereafter defer from contending for medium access during the DPI 1610. Then, STA 106A may transmit data 1630, using the dedicated protocol, to one or more other devices during the DPI 1610.

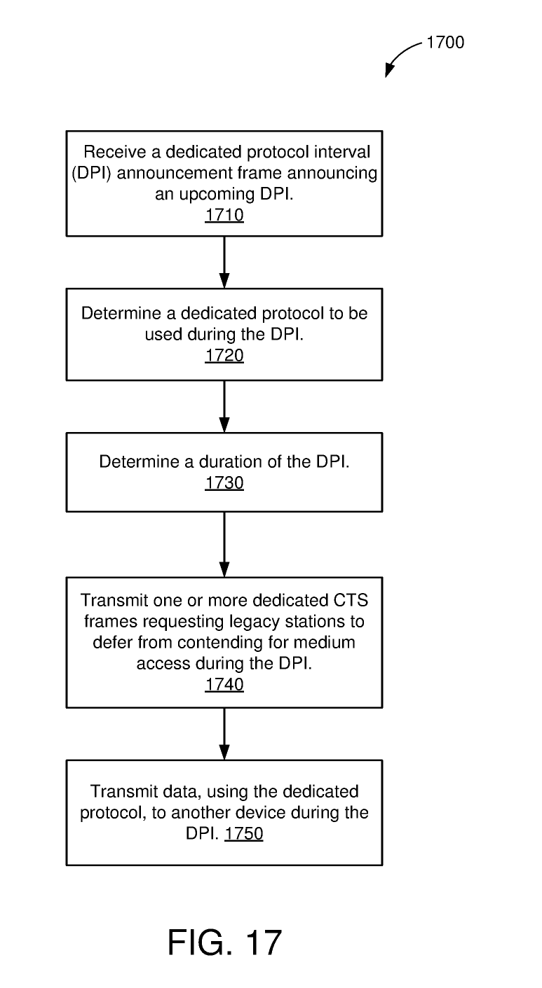

FIG. 17 is an illustrative flow chart depicting an example operation 1700 for coordinating a dedicated protocol interval, in accordance with example embodiments. The example operation 1700 is described below with respect to the wireless device 200 of FIG. 2. As described above, the wireless device 200 may be an access point (e.g., AP 104 of FIG. 1) or a station (e.g., one of STAs 106A-106D of FIG. 1).

First, the wireless device 200 may receive a DPIA frame that announces an upcoming DPI (1710). The DPIA frame, which may be received using any suitable components of wireless device 200, may indicate a start time of the DPI, an end time of the DPI, a duration of the DPI, a periodicity of the DPI, and/or a communication protocol to be used for data transmissions during the DPI.

The wireless device 200 may then determine a dedicated protocol to be used during the DPI (1720). In some aspects, the dedicated protocol may be specified in the DPIA frame, as described above. In other aspects, the dedicated protocol may be specified in one or more previously received management frames, beacon frames, or other suitable frames. In some implementations, the wireless device 200 may determine the dedicated protocol by executing DPI management SW module 244 of FIG. 2.

The wireless device 200 may also determine a duration of the DPI (1730). In some aspects, the duration of the DPI may be indicated in the DPIA frame. In other aspects, the duration of the DPI may be indicated in one or more previously received management frames, beacon frames, or other suitable frames. In some implementations, the wireless device may determine the duration of the DPI by executing DPI management SW module 244 of FIG. 2.

Then, the wireless device 200 may transmit one or more dedicated CTS frames requesting legacy stations to defer from contending for medium access during the DPI (1740). The one or more dedicated CTS frames may each contain the duration of the DPI and/or one or more reserved receiver addresses. As described above, the one or more reserved receiver addresses may be used to announce a dedicated protocol interval (DPI) to HEW devices while preventing legacy devices from contending for medium access during the DPI. More specifically, for at least some embodiments, the one or more reserved receiver addresses may include a protocol identifier indicating the dedicated protocol and may include a sequence identifier value indicating a remaining number of times to retransmit dedicated CTS frames.

In some aspects, the dedicated CTS frame may be transmitted after a time period (e.g., a DCIFS duration) following reception of the DPIA frame. In other aspects, the dedicated CTS frame may be transmitted at a scheduled time after reception of the DPIA frame.

In some embodiments, the dedicated CTS frame may be the CTS frame 300 depicted in FIG. 3A. The wireless device 200 may create the dedicated CTS frame 300 by executing frame formation and exchange SW module 243 and/or the DPI management SW module 244 of FIG. 2. The wireless device 200 may transmit the dedicated CTS frame using one or more of antennas 250(1)-250(n), transceivers 211, baseband processor 212, frame formatting circuitry 222, frame formation and exchange SW module 243, and DPI management SW module 244 of FIG. 2.

After transmitting the one or more dedicated CTS frames, the wireless device 200 may transmit data, using the dedicated protocol, to another device during the DPI (1750). In some aspects, the dedicated protocol may be indicated by the DPIA frame (or by another suitable frame such as a management frame or a beacon frame). In other aspects, the wireless device 200 may select the dedicated protocol to be used during the DPI by executing the channel access mechanism selection SW module 245 of FIG. 2. The wireless device 200 may transmit the data using one or more of antennas 250(1)-250(n), transceivers 211, baseband processor 212, frame formation and exchange SW module 243, and DPI management SW module 244 of FIG. 2.

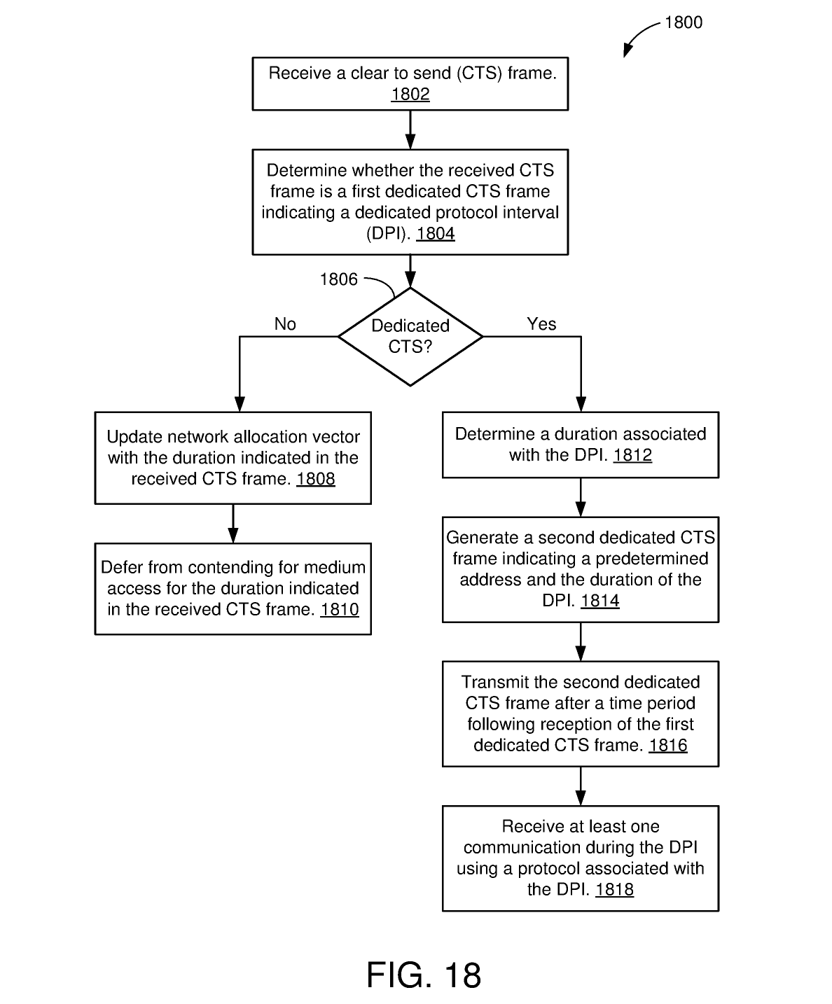

FIG. 18 is an illustrative flow chart depicting an example operation 1800 for coordinating a dedicated protocol interval, in accordance with example embodiments. The example operation 1800 is described below with respect to the wireless device 200 of FIG. 2. As described above, the wireless device 200 may be an access point (e.g., AP 104 of FIG. 1) or a station (e.g., one of STAs 106A-106D of FIG. 1).

First, the wireless device 200 may receive a CTS frame (1802). The CTS frame may be received using one or more components of wireless device 200 of FIG. 2 (e.g., one or more of antennas 250(1)-250(n), transceivers 211, baseband processor 212, frame formation and exchange SW module 243, and DPI management SW module 244).

The wireless device 200 may determine whether the received CTS frame is a first dedicated CTS frame indicating a dedicated protocol interval (DPI) (1804). The wireless device 200 may determine whether the received CTS frame contains a specific MAC address that indicates a protocol function rather than identifying a particular receiving device. In some aspects, the specific MAC address may be a protocol identifier address that includes a protocol identifier value and a sequence identifier value, for example, as described above with respect to FIG. 3B. In some implementations, the wireless device 200 may determine whether the received CTS frame is a first dedicated CTS frame by executing DPI management SW module 244 of FIG. 2.

If the wireless device 200 determines that the received CTS frame is not a first dedicated CTS frame indicating a DPI, as tested at 1806, then the wireless device 200 may update its network allocation vector (NAV) with the duration indicated in the received CTS frame (1808). Thereafter, the wireless device 200 may defer from contending for medium access for the duration indicated in the received CTS frame (1810).

Conversely, if the wireless device 200 determines that the received CTS frame is a first dedicated CTS frame indicating a DPI, as tested at 1806, then the wireless device 200 may determine a duration associated with the DPI (1812). In some aspects, the duration may be indicated by the first dedicated CTS frame. In other aspects, the duration may be associated with the dedicated protocol, or may have been received by the wireless device in a previous communication (e.g., a beacon frame or management frame). In some implementations, the wireless device 200 may determine the duration by executing DPI management SW module 244 of FIG. 2.

The wireless device 200 may generate a second dedicated CTS frame indicating a predetermined address and the duration associated with the DPI (1814). In some implementations, the wireless device 200 may generate the second dedicated CTS frame by executing the frame formation and exchange SW module 243 and/or the DPI management SW module 244 of FIG. 2. It is noted that the wireless device 200 may not generate a second dedicated CTS frame if the specific address contained in the first dedicated CTS frame is a protocol identifier address including a sequence identifier value that is greater than or equal to a maximum value.

Next, the wireless device 200 may transmit the second dedicated CTS frame after a time period following reception of the first dedicated CTS frame (1816). In some aspects, the time period may be a dedicated CTS interframe space (DCIFS) duration. In other aspects, the time period may be an inter-CTS frame space (ICFS) duration. In still other aspects, the time period may be a prescheduled time or a time determined according to a dedicated protocol associated with the DPI. The second dedicated CTS frame may be transmitted using one or more components of wireless device 200 (e.g., one or more of antennas 250(1)-250(n), transceivers 211, baseband processor 212, frame formatting circuitry 222, frame formation and exchange SW module 243, and DPI management SW module 244).

Then, the wireless device 200 may receive at least one communication during the DPI using a protocol associated with the DPI (1818). In some aspects, the protocol may be a dedicated protocol indicated in the DPIA frame, in a previously received management frame, or in a previously received beacon frame. In other aspects, the protocol may be a dedicated protocol associated with the specific MAC address contained in the dedicated CTS frame. In some implementations, the wireless device 200 may select the protocol by executing the channel access mechanism selection SW module 245 of FIG. 2. The at least one communication may be received using one or more components of wireless device 200 (e.g., one or more of antennas 250(1)-250(n), transceivers 211, baseband processor 212, the frame formation and exchange SW module 243, and the DPI management SW module 244).

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, the example embodiments have been described with reference to specific example embodiments thereof. It will, however, be evident that various modifications and changes may be made thereto without departing from the broader scope of the disclosure as set forth herein. The specification and drawings are, accordingly, to be regarded in an illustrative sense rather than a restrictive sense.

What is claimed is:

1. A method for signaling a dedicated protocol interval (DPI), the method comprising:
receiving a DPI announcement (DPIA) frame;
determining, based on the DPIA frame, a duration of the DPI and a dedicated protocol for the DPI;
transmitting one or more dedicated clear-to-send (CTS) frames requesting legacy stations to defer from contending for medium access during the DPI; and
transmitting data, using the dedicated protocol, to another device during the DPI.

2. The method of claim 1, wherein the DPIA frame is received using the dedicated protocol.

3. The method of claim 1, wherein the DPIA frame and the one or more dedicated CTS frames each contain one or more reserved receiver addresses.

4. The method of claim 3, wherein the one or more reserved receiver addresses include a unicast media access control (MAC) address.

5. The method of claim 3, wherein the one or more reserved receiver addresses indicate the dedicated protocol.

6. The method of claim 5, wherein the one or more reserved receiver addresses include a sequence identifier value indicating a remaining number of times to retransmit dedicated CTS frames.

7. The method of claim 6, wherein transmitting the one or more dedicated CTS frames further comprises:
determining that a first dedicated CTS frame includes a sequence identifier value less than a maximum value;
incrementing the sequence identifier value; and
transmitting a second dedicated CTS frame containing a reserved receiver address including the incremented sequence identifier value.

8. The method of claim 6, wherein transmitting the one or more dedicated CTS frames further comprises:
determining not to transmit a second dedicated CTS frame based on determining that a first dedicated CTS frame includes a sequence identifier value not less than a maximum value.

9. The method of claim 1, wherein the DPIA frame is a dedicated CTS frame.

10. The method of claim 1, wherein the DPIA frame indicates a time for transmission of the one or more dedicated CTS frames.

11. The method of claim 1, wherein the DPIA frame indicates a requested number of dedicated CTS frames, and transmitting the one or more dedicated CTS frames includes transmitting the requested number of dedicated CTS frames.

12. A wireless device, comprising:
one or more processors;
one or more transceivers; and
a memory storing one or more programs comprising instructions that, when executed by the one or more processors, cause the wireless device to signal a dedicated protocol interval (DPI) by performing operations comprising:
receiving a DPI announcement (DPIA) frame;
determining, based on the DPIA frame, a duration of the DPI and a dedicated protocol for the DPI;
transmitting one or more dedicated clear-to-send (CTS) frames requesting legacy stations to defer from contending for medium access during the DPI; and
transmitting data, using the dedicated protocol, to another device during the DPI.

13. The wireless device of claim 12, wherein the DPIA frame is received using the dedicated protocol.

14. The wireless device of claim 12, wherein the DPIA frame and the one or more dedicated CTS frames contains one or more reserved receiver addresses.

15. The wireless device of claim 14, wherein the one or more reserved receiver addresses include a unicast media access control (MAC) address.

16. The wireless device of claim 14, wherein the one or more reserved receiver addresses indicate the dedicated protocol.

17. The wireless device of claim 16, wherein the one or more reserved receiver addresses include a sequence identifier value indicating a remaining number of times to retransmit dedicated CTS frames.

18. The wireless device of claim 17, wherein execution of the instructions to transmit the one or more dedicated CTS frames causes the wireless device to perform operations further comprising:
determining that a first dedicated CTS frame includes a sequence identifier value less than a maximum value;
incrementing the sequence identifier value; and
transmitting a second dedicated CTS frame containing a reserved receiver address including the incremented sequence identifier value.

19. The wireless device of claim 17, wherein execution of the instructions to transmit the one or more dedicated CTS frames causes the wireless device to perform operations further comprising:
determining not to transmit a second dedicated CTS frame based on determining that a first dedicated CTS frame includes a sequence identifier value not less than a maximum value.

20. The wireless device of claim 12, wherein the DPIA frame is a dedicated CTS frame.

21. The wireless device of claim 12, wherein the DPIA frame indicates a time for transmission of the one or more dedicated CTS frames.

22. The wireless device of claim 12, wherein the DPIA frame indicates a requested number of dedicated CTS frames, and transmitting the one or more dedicated CTS frames includes transmitting the requested number of dedicated CTS frames.

23. A non-transitory computer-readable storage medium storing one or more programs containing instructions that, when executed by one or more processors of a wireless device, cause the wireless device to signal a dedicated protocol interval (DPI) by performing operations comprising:
receiving a DPI announcement (DPIA) frame;
determining, based on the DPIA frame, a duration of the DPI and a dedicated protocol for the DPI;
transmitting one or more dedicated clear-to-send (CTS) frames requesting legacy stations to defer from contending for medium access during the DPI; and
transmitting data, using the dedicated protocol, to another device during the DPI.

24. The non-transitory computer-readable storage medium of claim 23, wherein the DPIA frame and the one or more dedicated CTS frames contain one or more reserved receiver addresses.

25. The non-transitory computer-readable storage medium of claim 24, wherein the one or more reserved receiver addresses indicate the dedicated protocol.

26. The non-transitory computer-readable storage medium of claim 24, wherein the one or more reserved receiver addresses include a sequence identifier value indicating a remaining number of times to retransmit dedicated CTS frames.

27. The non-transitory computer-readable storage medium of claim 26, wherein execution of the instructions to transmit the one or more dedicated CTS frames causes the wireless device to perform operations further comprising:
determining that a first dedicated CTS frame includes a sequence identifier value less than a maximum value;
incrementing the sequence identifier value; and
transmitting a second dedicated CTS frame containing a reserved receiver address including the incremented sequence identifier value.

28. The non-transitory computer-readable storage medium of claim 26, wherein execution of the instructions to transmit the one or more dedicated CTS frames causes the wireless device to perform operations further comprising:
determining not to transmit a second dedicated CTS frame based on determining that a first dedicated CTS frame includes a sequence identifier value not less than a maximum value.

29. The non-transitory computer-readable storage medium of claim 23, wherein the DPIA frame indicates a requested number of dedicated CTS frames, and transmitting the one or more dedicated CTS frames includes transmitting the requested number of dedicated CTS frames.

30. A wireless device for signaling a dedicated protocol interval (DPI), the wireless device comprising:
means for receiving a DPI announcement (DPIA) frame;
means for determining, based on the DPIA frame, a duration of the DPI and a dedicated protocol for the DPI;
means for transmitting one or more dedicated clear-to-send (CTS) frames requesting legacy stations to defer from contending for medium access during the DPI; and
means for transmitting data, using the dedicated protocol, to another device during the DPI.
